(19) United States
(12) Patent Application Publication
(10) Pub. No.: US 2026/0294161 A1
(43) Pub. Date: Oct. 1, 2026

(54) Innovative System for the Production and Consumption of Intelligent Coffee (IQCoffee)

(71) Applicant: HUMBERTO TABARES CHEO, MIAMI, FL (US)

(72) Inventor: HUMBERTO TABARES CHEO, MIAMI, FL (US)

(21) Appl. No.: 19/090,217

(22) Filed: Mar. 25, 2025

(51) Int. Cl. A47J 31/40; A47J 31/44; G06F 1/16

(52) U.S. Cl. CPC A47J 31/40; A47J 31/4403; G06F 1/163

(57) ABSTRACT

The IQCoffee system revolutionizes coffee consumption by integrating artificial intelligence, biometric sensors, and nanotechnology to personalize each cup based on the user's physiological parameters in real time. Its optimized formulation combines nootropics, adaptogens, and antioxidants, improving cognitive function, metabolism, and longevity. Through connected devices, artificial intelligence analyzes biomarkers such as heart rate, glucose levels, and sleep patterns, adjusting the coffee's composition to boost energy, focus, and well-being without adverse effects. Its blockchain-based traceability guarantees the authenticity and quality of each ingredient, while its production infrastructure allows for the distribution of bean, instant, capsule, and liquid extract versions. More than a beverage, IQCoffee is a biological optimization tool designed to evolve with each user, redefining the role of coffee in personalized nutrition and biohacking for healthy longevity.

### BACKGROUND OF THE INVENTION

Coffee, as we know it today, has accompanied human civilization for a long time, constituting an important part of its history. It has been much more than a simple stimulating beverage, becoming an almost ritual in families across the most diverse latitudes. Its origin dates back to ancient African and Arab cultures, where the consumption of these beans and their extracts was valued not only for their ability to maintain wakefulness, but also for their effects on mental clarity and mood. Over time, its popularity spread throughout Europe and the rest of the world, becoming a symbol of concentration, productivity, and social interaction. And at this point, if we stop to think about it, we realize that, despite its centuries of history, coffee has evolved relatively little, being limited in most cases to its stimulating effect derived from caffeine.

This invention falls within the field of functional foods and technologies applied to the personalization of coffee consumption. More specifically, it refers to a smart coffee system that integrates biometric sensors, artificial intelligence algorithms, and advanced bioactive extraction and encapsulation technology to optimize consumer cognitive performance and well-being.

Let's now explain in more detail for better understanding, as this invention sits at the intersection of functional foods and the application of advanced technologies in personalized coffee consumption. It is a revolutionary system that redefines the way coffee is perceived, prepared, and consumed, integrating science, technology, and well-being into a completely innovative experience. Its purpose is to optimize health, cognitive performance, and physiological balance through a unique combination of biometric sensors, artificial intelligence, and advanced bioactive compound extraction and encapsulation methods.

In recent years, the functional food industry has begun exploring new ways to enhance the benefits of coffee, incorporating ingredients such as MCTs, collagen, adaptogenic mushrooms, and essential amino acids. Most of these products have focused on physical performance, metabolic health, or sustained energy, neglecting coffee's true potential as an agent that optimizes cognitive function, promotes longevity, and improves health in all its integrative aspects. The growing demand for solutions that not only provide a momentary boost but also protect and strengthen the brain over the long term could undoubtedly give rise to a new category, and that is why we present smart coffee in these brief pages below.

IQCoffee emerges as an innovative response to this need, combining the most advanced scientific knowledge in neuroscience, biochemistry, and longevity with the sensorial pleasure of an ancient beverage. Unlike conventional functional coffees, IQCoffee not only provides an immediate energy boost but also optimizes neuronal plasticity, improves synapses, and protects cognitive function over time. Its formula integrates bioactive compounds such as mitochondrial antioxidants, natural nootropics, adaptogens, and essential minerals, all strategically selected to boost brain activity and promote optimal neurometabolic health.

But what truly sets IQCoffee apart is its interactive nature. This is not a static coffee, but a dynamic experience that evolves with the user. Through a personalized approach, IQCoffee allows consumption to be tailored to each person's individual needs, optimizing its effects based on the time of day, level of cognitive activity, and personal mental performance goals. This interaction is achieved through recommendations based on consumption patterns and physiological responses, creating a direct connection between the science of wellness and the everyday experience of enjoying a cup of coffee.

The world is moving towards an era where longevity is not only measured in years, but in quality of life. In this context, IQcafé represents a natural evolution in the way we think about coffee, transforming it into a bio optimization tool that not only awakens the mind, but also strengthens and protects it. This is the new frontier of smart coffee, where tradition meets science to offer a real and sustainable solution for cognitive well-being and healthy longevity.

### INVENTION SUMMARY

IQCoffee marks a revolution in functional nutrition, designed to empower the mind, optimize metabolism, and prolong a healthy life. Available in two variants—generic, with a balanced formulation, and personalized, tailored to each individual—it integrates an interactive feedback system that allows its composition to be adjusted according to the user's needs in real time. Backed by advanced technology, it combines bioactive ingredients that improve mental clarity, stress resistance, and sustained energy without adverse effects. It also strengthens cognitive function, supports cardiovascular health, and optimizes physical performance. It is available in various formats, including vacuum-packed beans, instant coffee, liquid with coconut milk, and coffee machine-compatible capsules, ensuring accessibility and customization. Its real-time customization technology considers key biomarkers such as heart rate variability, glucose levels, and sleep quality, in addition to the user's age and circadian rhythm, to adjust its composition according to the time of day and the specific needs of each life stage. With its integration of adaptogens, nootropics, and antioxidants, IQCoffee redefines functional nutrition, becoming a key tool for well-being, performance, and quality of life. Its blockchain-based traceability guarantees the authenticity and quality of each ingredient, while its sustainable production infrastructure balances innovation and respect for the environment. More than a beverage, IQCoffee is an intelligent bio-optimization system that evolves with each user, delivering energy, focus, and vitality in every cup.

### DESCRIPTION OF THE DRAWING

N/A

### DETAILED DESCRIPTION OF THE INVENTION

IQCoffee's smart platform redefines the smart functional coffee experience by integrating cutting-edge biomedical technology, artificial intelligence, and an advanced traceability system. Designed to dynamically adapt to each user's individual needs, this platform analyzes physiological and metabolic parameters in real time, enabling precise customization of each coffee dose. Its purpose is to enhance health and cognitive performance through intelligent algorithms that interpret biological data and optimize the coffee formulation according to the body's specific requirements. With IQCoffee, each cup becomes a scientific tool for well-being and high performance.

Biometric Sensor Module: The technology behind IQCoffee incorporates cutting-edge wearable devices, such as smartwatches, biometric rings, and advanced skin sensors, to collect key physiological data in real time. These sensors monitor variables such as heart rate variability, oxygenation levels, metabolic activity, and stress biomarkers, enabling precise adaptation of the coffee composition to the user's individual needs. Thanks to this biomedical integration, each cup of IQCoffee becomes a personalized tool for optimizing well-being, energy, and cognitive performance. Artificial Intelligence (AI) Module: At the core of IQCoffee is an advanced artificial intelligence system capable of interpreting the user's biometric data in real time. Using machine learning algorithms and predictive modeling, this module analyzes physiological patterns and adapts the coffee formulation based on metabolic status, alertness, sleep quality, and other key factors. The AI not only optimizes the dosage of functional ingredients such as antioxidants, adaptogens, and micronutrients, but also learns and evolves with each interaction, fine-tuning each cup to deliver the perfect balance of energy, focus, and well-being.

Nutritional Personalization Module: The technology behind IQCoffee takes functional nutrition to a new level by determining the optimal combination of bioactive ingredients tailored to each user's specific needs. Through continuous analysis of biomarkers and physiological patterns, this module selects and adjusts in real time the ideal ratio of adaptogens, antioxidants, nootropics, and other emerging compounds with the potential to optimize health and prolong longevity. With a scientific foundation in nutrigenomics and biohacking, IQCoffee not only maximizes cognitive and physical performance but is also projected as a revolutionary tool in the evolution of personalized nutrition for holistic well-being and healthy aging.

Production and Distribution Module: IQCoffee closes the personalization cycle with an advanced manufacturing system that translates biometric and nutritional data in real time into functional coffee blends tailored to each user. This module is connected to an intelligent production infrastructure that combines automated precision, quality control, and traceability for every batch. Thanks to this integration, optimized formulations can be shipped directly to the consumer in various formats, from capsules to instant blends and specialized infusions. With this approach, IQCoffee guarantees a personalized and accessible wellness experience, redefining how coffee becomes a high-performance tool for health and longevity. Blockchain Traceability Module: The IQCoffee platform incorporates a decentralized blockchain-based registration system to ensure the authenticity, quality, and transparency of every ingredient used in its formulations. This module allows real-time tracking of the origin, processing, and certification of each bioactive compound, ensuring unprecedented standards of purity and efficacy. By eliminating intermediaries and providing an immutable history of each batch, IQCoffee offers reliable traceability that reinforces consumer confidence and elevates nutritional security to a new level.

User Interface (App/Web): The IQCoffee experience is complemented by an intuitive and advanced digital platform, available in mobile and web applications. Through this interface, users can monitor their key biomarkers in real time, visualize the impact of each blend on their cognitive performance and well-being, make personalized adjustments to their coffee formulation, and receive AI-based recommendations. Additionally, the platform offers detailed analytics, consumption history, personalized alerts, and connection to biometric devices for continuous optimization. With this tool, IQCoffee not only provides functional coffee, but also a health and longevity experience fully tailored to each individual. Technological Infrastructure—Back-End: IQCoffee's core operations are supported by a cloud-based server infrastructure capable of real-time data processing. This advanced system enables the seamless integration of information from biometric sensors, artificial intelligence modules, and blockchain traceability records, ensuring an immediate and personalized response for each user. With algorithms optimized for big data analysis and machine learning, IQCoffee's back-end continuously processes and adjusts formulations based on detected physiological and nutritional parameters, ensuring a precise, safe, and constantly evolving functional coffee experience.

Front-End: The IQCoffee experience is realized through web and mobile applications designed for fluid, intuitive, and highly personalized interaction. With an interface optimized for real-time visualization of biometric data, dynamic coffee formulation adjustments, and intelligent recommendations, the front-end allows users to take full control of their experience. Integrated with AI and traceability systems, this digital ecosystem not only offers efficient navigation but also adapts to individual preferences, ensuring accessibility, security, and an immersive experience that optimizes performance and longevity.

Integrations: IQCoffee is designed for a fully connected ecosystem through advanced APIs that facilitate integration with IoT devices and health monitoring systems. This connectivity enables real-time synchronization with smartwatches, biometric rings, skin sensors, and other wearable technologies, ensuring accurate collection of physiological and metabolic data. Furthermore, its compatibility with digital health platforms and wellness apps expands its customization capabilities, optimizing each functional coffee formulation based on the user's current state. With these integrations, IQCoffee becomes a revolutionary tool in biohacking and precision nutrition.

Operational Flow—User Registration: The process begins with the creation of a personalized profile, where the user enters their health data, lifestyle habits, wellness goals, and consumption preferences. Through an intuitive interface, the system collects key information, such as physiological parameters, energy levels, sleep patterns, and cognitive needs, allowing IQCoffee to precisely tailor its formulations. This initial registration lays the foundation for an optimized and constantly evolving experience, where each cup of coffee becomes a scientifically designed tool to enhance health and longevity.

Biometric Monitoring: Once registered, IQCoffee syncs with biometric devices such as smartwatches, monitoring rings, and skin sensors to collect real-time physiological data. This continuous monitoring system analyzes variables such as heart rate, heart rate variability, stress levels, sleep quality, and metabolic activity, allowing for an accurate assessment of the user's status. Thanks to this advanced monitoring, IQCoffee dynamically adjusts the formulation of each blend, ensuring an optimal balance of energy, focus, and well-being throughout the day. Analysis and Prediction: IQCoffee's artificial intelligence module continuously processes the collected biometric data to identify patterns and trends in user health and behavior. Using advanced machine learning algorithms, the AI adjusts the user's behavior in real time. IQCoffee takes real-time coffee formulation into account, incorporating specific functional ingredients that align with identified needs, such as adaptogens for stress relief or nootropics to improve concentration. This predictive capability allows IQCoffee to offer a truly personalized drinking experience, optimizing each individual's health and cognitive performance.

Real-Time Optimization: IQCoffee redefines functional coffee personalization with dynamic adjustment of ingredients and brewing properties based on real-time biometric data and physiological patterns. Through artificial intelligence and machine learning algorithms, the formulation instantly adapts to optimize energy, focus, recovery, and overall well-being. This adjustment considers factors such as stress level, sleep quality, and metabolic activity, allowing each cup of coffee to be unique and aligned with the user's specific needs at every moment of the day.

Smart Brewing: IQCoffee takes personalization to the next level with a smart coffee maker capable of receiving the optimized recipe in real time and automatically adjusting variables such as temperature, pressure, and concentration. This precision brewing system ensures that each cup accurately reflects the personalized formulation designed to maximize the user's cognitive performance, energy, and well-being. Integrated with artificial intelligence and connected to the biometric monitoring ecosystem, the coffee maker adapts each brew to optimize the bioavailability of the active ingredients, ensuring an unprecedented functional coffee experience.

Continuous Feedback: IQCoffee incorporates a machine learning system that evolves with each use, continually refining the formulation and user experience. Through the analysis of biometric data, consumption habits, and individual responses, artificial intelligence dynamically adjusts ingredients and brewing parameters to maximize benefits over time. This progressive optimization allows each cup of coffee to be increasingly precise and effective, adapting to the user's physiological changes and needs, ensuring a personalized and constantly improving approach to wellness.

Machine Learning and Predictive AI: IQCoffee employs advanced machine learning algorithms and predictive artificial intelligence to analyze physiological data in real time and customize the formulation of each coffee blend. Using models trained with biometric information, behavioral patterns, and scientific studies on longevity and cognitive performance, AI dynamically adjusts functional ingredients and brewing parameters. This approach allows the user to anticipate their needs and optimize their well-being, ensuring a functional coffee experience that continuously evolves and is personalized.

Blockchain: IQCoffee guarantees maximum transparency, authenticity, and quality in every ingredient through a blockchain infrastructure. This decentralized system allows for complete traceability of each component, from its origin to its integration into the customized formulation. Through unalterable and verifiable records, each batch of functional coffee is guaranteed to meet the highest standards of purity, sustainability, and efficacy. Blockchain technology not only protects against fraud or adulteration but also gives users complete confidence in the quality and impact of the selected ingredients on their well-being and longevity.

Big Data: IQCoffee employs Big Data technology to analyze large volumes of information on consumption patterns, physiological responses, and individual preferences. Through advanced processing of this data, the system continuously optimizes recipes, identifying trends and correlations that enable more precise and effective formulation adjustments. This analytical capability enhances the personalization of functional coffee, ensuring that each user receives an experience tailored to their specific needs, with ingredients and preparations that evolve based on their well-being and cognitive performance.

IoT (Internet of Things): IQCoffee integrates an advanced network of IoT sensors into smart coffee makers and wearable devices to collect real-time physiological and consumer data. Smartwatches, biometric rings, and skin sensors monitor key variables such as heart rate, stress levels, sleep quality, and metabolic activity, while smart coffee makers adjust temperature, pressure, and concentration based on the personalized formulation. This interconnectivity enables a highly optimized functional coffee experience, where each cup dynamically adapts to the user's needs, maximizing their health, cognitive performance, and longevity.

IQCoffee could evolve to integrate with an even wider range of biometric devices and health platforms currently on the market, such as Apple Health, Google Fit, and other advanced monitoring systems. This expansion will enable deeper and more accurate analysis of physiological data, improving real-time formulation personalization. Furthermore, interoperability with multiple technologies will strengthen the predictive capabilities of artificial intelligence, optimizing the user experience and enhancing benefits in terms of health, energy, cognitive performance, and healthy longevity.

Integration with Personalized Nutrition Plans: IQCoffee could further expand its ecosystem by synchronizing with personalized nutrition programs, allowing the coffee formulation to adapt not only to biometric data but also to the user's diet and health goals. This integration will enable dynamic adjustments to the composition of functional coffee, aligning it with specific nutritional requirements, such as ketogenic diets, anti-inflammatory approaches, or longevity strategies. With this enhancement, IQCoffee will not only optimize cognitive and physical performance but will also become a key pillar of a healthy and personalized lifestyle.

IQCoffee will incorporate advanced nanotechnology to optimize the absorption and efficacy of the active ingredients in each formulation. Through molecular encapsulation techniques and bioavailable nanoparticles, adaptogens, antioxidants, and nootropics will be more stable and absorb more efficiently at the cellular level. This innovation will allow functional compounds to more easily cross biological barriers, maximizing their impact on metabolism, brain function, and longevity. With this optimization, each cup of IQCoffee will not only deliver exceptional flavor but will also act as a powerful vehicle for human well-being and performance.

IQCoffee redefines the concept of functional coffee by merging cutting-edge technology with the most advanced principles of personalized nutrition. Through an intelligent ecosystem based on artificial intelligence, IoT, blockchain, and nanotechnology, each cup of coffee becomes an optimized tool to enhance health, cognitive performance, and longevity.

Thanks to the real-time collection and analysis of physiological data, IQCoffee dynamically adjusts its formulation, ensuring an experience completely tailored to each user's individual needs. This integration of science and wellness sets a new standard in coffee consumption, transforming it into a strategic ally for those seeking to maximize their energy, focus, and quality of life with every sip.

IQCoffee, a comprehensive ecosystem protected by a strategic patent, represents not only a revolution in functional coffee consumption by creating a fully integrated ecosystem of personalization, traceability, and health optimization, but also the first prototype of a human-interactive, intelligent beverage. Through the combination of artificial intelligence, biometrics, blockchain, and nanotechnology, it transforms each cup into an experience tailored to the user's individual needs. This technological synergy enables the development of a unique, multifaceted protection strategy, a unifying concept that is key to understanding everything that may arise from this unique patent proposal.

The coffee's composition incorporates functional compounds optimized using nanotechnology to improve its bioavailability and enhance its benefits. The intelligent brewing system adjusts parameters such as temperature, pressure, and concentration in real time to ensure the ideal formulation for each drink. The biometric personalization software uses artificial intelligence to analyze physiological data and create constantly evolving consumer profiles.

Blockchain-based traceability guarantees the authenticity, quality, and origin of each ingredient, ensuring safe and transparent consumption. Furthermore, the development of new functional coffee formats, such as capsules, liquid and instant extracts enriched with adaptogens, nootropics, and antioxidants, expands the possibilities for customization and maximizes health benefits. IQCoffee not only redefines the concept of coffee, but also sets a new standard in precision nutrition and personalized wellness, protected by a framework of innovation that guarantees its exclusivity in the global market.

Coffee consumption has been a globally widespread practice for centuries, but like everything else, evolution and advances in food technology, artificial intelligence, and biotechnology have This has enabled the creation of a new concept of functional smart coffee. The present invention relates to a smart coffee system that combines functional ingredients with optimized processing and advanced technology to personalize coffee consumption according to consumers' needs. This invention seeks to overcome the limitations of conventional coffee production and consumption methods, offering improved benefits in terms of health, personalization, and sustainability.

For centuries, coffee has been much more than a simple beverage. Its impact on culture, productivity, and human well-being has made it a fundamental pillar in the lives of millions of people around the world. Its consumption is deeply rooted in the daily routines of individuals of all ages and cultures, not only for its unmistakable flavor and aroma, but also for its ability to improve concentration, alertness, and cognitive function. Unlike other beverages, coffee has been the subject of extensive scientific research that has demonstrated its benefits on cardiovascular, metabolic, and neuroprotective health, positioning it as a natural ally in the pursuit of healthy longevity. In the current era, where technology provides us with unprecedented tools to understand and optimize the functioning of the human body, coffee presents itself as the ideal vehicle for integrating advances in artificial intelligence, biometrics, and precision nutrition. Unlike other functional foods, its global acceptance and daily consumption make it the perfect medium for introducing a biotechnological personalization system that responds to individual needs in real time. The combination of biometric sensors with optimized formulations allows coffee to evolve beyond a stimulating beverage to become an interactive resource with the body, capable of enhancing physical and mental performance, regulating metabolic processes, and contributing to overall well-being.

This invention materializes this vision by developing an intelligent coffee system (IQCoffee) that, thanks to the synergy between science and technology, redefines the way humans access the benefits of coffee. This is not just an evolution in consumption, but a step forward in the transformation of human beings into a species that surpasses itself, optimizing its biology, improving its quality of life, and prolonging its healthy longevity. With each cup of smart coffee, the individual leaves behind passive consumption and embraces a personalized experience, designed to enhance their capabilities and promote holistic well-being in a constantly evolving world.

This invention redefines the concept of coffee, transforming it into an intelligent platform (IQcoffee), designed to optimize health, cognitive performance, and longevity. More than a simple beverage, it is an advanced system that combines carefully selected bioactive ingredients to boost energy, improve concentration, modulate stress, and promote cell regeneration. Through an innovative formulation process, the coffee is enriched with highly bioavailable compounds that act in synergy with caffeine and natural polyphenols, maximizing its benefits and setting a new standard in functional beverages.

The core of this innovation lies in its capacity for customization and continuous evolution. An integrated digital platform collects physiological data from users through smart devices, allowing for precise adaptation of each preparation to their specific needs. Biometric sensors, wearables, and smart coffee makers work together to analyze variables, including circadian rhythm, pulse variability, and stress levels, adjusting proportions and consumption recommendations in real time. The platform's artificial intelligence learns with each interaction, perfecting formulations and offering personalized support toward an optimal state of well-being.

The smart coffee (IQcoffee) we offer comes in three formats: vacuum-packed ground beans, dry instant coffee, and capsules compatible with automated systems, ensuring versatility and convenience without compromising the integrity of the active ingredients. Its formulation integrates adaptogens, antioxidants, essential micronutrients, and other functional compounds, each selected for its scientific backing and ability to improve cognitive function, stress resistance, and metabolic balance.

This invention not only responds to emerging trends in health and wellness, but also inaugurates a new paradigm in precision nutrition. It is the convergence of biotechnology, artificial intelligence and neuroscience Introduced to everyday consumption, a tool designed to enhance modern life and expand its limits.

Smart coffee represents an unprecedented innovation in the field of functional nutrition and human optimization. It is not simply an evolution of traditional coffee, but a formulation designed with scientific precision to interact with the body's biological processes, enhancing cognitive ability, metabolic balance, and healthy longevity. Its composition incorporates a synergy of bioactive compounds, from adaptogens and antioxidants to essential minerals and neurochemical modulators, which work in harmony with human biology to maximize mental and physical performance.

This invention fuses advanced principles of biohacking and epigenetics, redefining the concept of a functional beverage. The integration of elements such as zinc and copper strengthens neuronal communication and brain plasticity, while the inclusion of ashwagandha and rhodiola rosea modulates the stress response, promoting a state of sustained focus without the peaks and falls associated with conventional caffeine. The addition of green tea and cocoa provides polyphenols with neuroprotective and cardiovascular properties, while dried ground coconut provides medium-chain triglycerides, a rapidly metabolized energy source for the brain.

The design of smart coffee transcends its composition to offer a versatile product, adapted to changing consumption habits. Its development in capsules compatible with leading coffee machines and its instant version guarantee accessibility and practicality without compromising the purity of its ingredients. Furthermore, the formulation can be integrated into advanced solutions, such as combinations with coconut milk enriched with high-impact supplements for vitality and well-being.

This coffee is not just a beverage; it is a tool for the comprehensive optimization of the human being. In a world where cognitive potential and biological resilience have become the new pillars of development, this invention redefines the interaction between nutrition and performance, setting a new standard in the evolution of functional consumption. Its impact lies not only in its immediate benefits, but also in its ability to reprogram and strengthen human biology, opening up a horizon of possibilities where the limits have yet to be defined.

This invention describes a smart coffee system that integrates functional formulations with an approach based on biometric data and individual user preferences. IQ Coffee is a smart functional coffee ecosystem that revolutionizes the way consumers experience this ancient beverage, integrating advanced technologies such as artificial intelligence, nanotechnology, precision fermentation, and blockchain traceability. It is not simply about improving coffee quality, but about transforming its consumption into a personalized tool for optimizing health, cognitive performance, and longevity. In an era where science has proven that nutrition is one of the fundamental keys to extending life expectancy and enhancing human well-being, IQ Coffee stands as the definitive answer to the need to integrate this knowledge into the daily lives of millions of people around the world. Coffee is the most consumed beverage globally after water, a tradition that transcends borders, cultures, and generations. Its consumption is not just a habit, but a ritual deeply rooted in the human experience, associated with social connection, creativity, and the awakening of consciousness. The unique combination of bioactive compounds presents in coffee, such as polyphenols, antioxidants, and caffeine, has demonstrated beneficial effects on brain health, metabolic function, and protection against neurodegenerative diseases. IQ Coffee leverages this legacy and elevates it to an unprecedented level, transforming the act of drinking coffee into a scientific and personalized experience, in which each cup is tailored to the consumer's specific needs, synchronizing with their biology in real time and evolving with them over time.

The system operates in two modalities designed to serve both the general consumer and users seeking a more advanced level of personalization. The first version consists of optimized formulations based on general wellness, energy, and metabolic health profiles, developed from predictive models and aggregated data. Using artificial intelligence, consumption patterns and common requirements are analyzed in different segments of the population, generating specific mixes for athletes, high-performance professionals, people with chronic stress, individuals with particular nutritional needs or those seeking to enhance their longevity through scientific cellular optimization strategies. These formulations are presented in high-purity granulated coffee and biodegradable capsules, both designed to maximize the bioavailability of their functional components and enhance the user's sensory experience.

The second option, aimed at those seeking a completely personalized experience, introduces cutting-edge technology capable of analyzing the consumer's biometric data in real time and adjusting the coffee composition based on their physiological state, stress level, metabolic profile, and individual goals. Through a smart coffee maker equipped with biometric sensors and IoT connectivity, real-time data is collected on variables such as cortisol levels, blood glucose, heart rate variability, hydration status, and circadian rhythms. This data is processed by advanced artificial intelligence algorithms that determine the optimal coffee formulation for each moment of the day, adjusting the concentration of caffeine, polyphenols, adaptogens, and nootropics according to the user's needs. Thus, coffee becomes not only a vehicle for personalized nutrition, but a dynamic tool for optimizing physical and mental health, designed to evolve with the individual and offer continuous support in their pursuit of well-being and peak performance.

This capacity for adaptive customization is further enhanced by the use of nanotechnology and precision fermentation, two scientific advances proven essential for improving the bioavailability and efficacy of the bioactive compounds present in coffee. Liposomal microencapsulation guarantees optimal absorption of functional ingredients, preventing their degradation and ensuring their prolonged release into the body. In this way, polyphenols, adaptogens, antioxidants, and essential minerals not only reach their sites of action in higher concentrations, but also exert a more lasting and potent effect, maximizing the benefits of coffee on health and longevity.

To guarantee the authenticity and quality of each batch of coffee, the system incorporates blockchain technology, which provides full traceability of the origin, processing, and customization of each formulation. Through QR codes and NFC technology, consumers can access detailed information about their consumption profile, the evolution of their physiological parameters, and personalized recommendations generated by artificial intelligence. Additionally, IQ Coffee introduces a liquid variant enriched with coconut milk and bioactive supplements, designed to offer a versatile and functional alternative that expands consumption possibilities and maximizes compatibility with different lifestyles and nutritional preferences.

The result is a completely new experience, in which coffee ceases to be a static beverage and becomes a system of personal evolution. In a world where healthy longevity and human optimization have become fundamental pillars of well-being, IQ Coffee marks the beginning of a new era in which personalized nutrition is organically integrated into daily routines, offering a sophisticated, scientific, and powerful solution for those seeking to live longer and better. It is not just a technological innovation, but a paradigm shifts in the way we conceive our relationship with food, biotechnology, and self-improvement—a silent revolution that, cup by cup, will redefine the future of longevity and human excellence.

Smart functional coffee represents an innovation that fuses biotechnology, artificial intelligence, food science, and neuroscience to redefine the impact of coffee consumption on human health and performance. Its development is based on a deep understanding of the biochemical mechanisms involved in the metabolism of the active compounds present in coffee and their interaction with the body, allowing for the optimization of its formulation to enhance its benefits. This system integrates multiple advanced technologies that work in synergy, enabling dynamic and precise personalization that elevates the consumer experience to a whole new level.

The core of the invention is based on an intelligent platform that combines hardware and software to analyze, adjust, and optimize the coffee's composition based on the user's physiological variables. Biometric sensors built into the smart coffee maker record key parameters such as heart rate variability, skin conductance and body temperature, while external devices such as smart watches and blood glucose monitors can be integrated into the system to expand analytical capabilities. This data is processed in real time by machine learning algorithms that identify patterns and determine the ideal formulation for each user at every moment of the day.

Smart functional coffee is not just an innovation; it is the perfect convergence of science, technology, and well-being. Its development draws on the latest advances in biotechnology, neuroscience, nanotechnology, and food science to create an unprecedented consumer experience. What was once simply a stimulating beverage has now become a human optimization tool, capable of enhancing cognition, balancing the body's biochemistry, and improving performance at all levels. Through precise formulation, supported by artificial intelligence algorithms, each cup of functional coffee is tailored to the unique needs of each individual, ensuring that its composition is not only optimal in terms of flavor and aroma, but also acts as a catalyst for health and longevity.

The design of this smart coffee is the result of a scientific revolution in the way we understand human metabolism and its interaction with bioactive compounds. Each ingredient is carefully selected not only for its immediate impact on the body but also for its cumulative effect on long-term health. The inclusion of adaptogens, nootropics, and antioxidants is not arbitrary; each compound has been validated by clinical studies demonstrating its ability to modulate key functions such as neuroplasticity, resistance to oxidative stress, and regulation of systemic inflammation. This synergy of ingredients is amplified by technologies such as liposomal microencapsulation, which ensures efficient and sustained absorption, maximizing the bioavailability of each component.

Beyond its physiological impact, smart functional coffee is positioned at the forefront of nutritional personalization. Thanks to biometric sensors and machine learning algorithms, the system adjusts formulations in real time, creating a dynamic product that evolves alongside the user. This approach represents a radical shift in the way we consume caffeine and other bioactive compounds, moving from a standardized model to a completely individualized experience. Artificial intelligence not only optimizes the dosage of each ingredient, but also predicts consumer trends and adjusts recommendations based on parameters such as stress level, sleep quality, physical activity, and metabolic response to each formulation.

Coffee is no longer a simple beverage but a wellness ritual deeply integrated into the consumer's lifestyle. Its impact goes beyond the personal level; traceability guaranteed by blockchain and sustainable production practices ensure that each coffee bean comes from responsible sources, promoting soil regeneration, ecosystem conservation, and fair trade. In an increasingly conscious market, where consumers demand transparency and environmental commitment, smart functional coffee is presented not only as the best option in terms of health and performance, but also as a symbol of the evolution toward more ethical and sustainable consumption.

From a marketing perspective, the value proposition of smart functional coffee is based on solid pillars: personalization, science, technology, and sustainability. The narrative surrounding the product not only highlights its individual benefits but also appeals to a growing desire in society to maximize human potential. It's no coincidence that the cognitive optimization and biohacking industries are experiencing exponential growth; people are actively seeking tools that allow them to improve their mental and physical performance, and smart functional coffee is positioned as the epicenter of this trend.

The design of the consumer experience is essential to consolidate the perception of the product as a disruptive innovation. Every detail, from the customization app interface to the aesthetics of the capsules and the interaction with health monitoring devices, is designed to generate an emotional connection with the user. The communication strategy focuses on conveying a vision of the future in which coffee ceases to be a routine habit and becomes a strategic ally for health and productivity. This vision is reinforced by marketing campaigns based on storytelling, where each consumer is the protagonist of their own journey toward optimal well-being.

The formulation of smart functional coffee goes beyond caffeine as the sole bioactive agent. Each capsule contains strategic combinations of adaptogens, nootropics and anti-inflammatory agents. Antioxidants designed to modulate different aspects of cognitive and physical performance. Among the most notable compounds are L-theanine, which optimizes synergy with caffeine to improve concentration without causing jitters; ashwagandha, an adaptogen that regulates stress and balances the hypothalamic-pituitary-adrenal axis; and coenzyme Q10, which enhances cellular energy production. These ingredients are microencapsulated using liposomal technology to ensure superior absorption and controlled release in the body, maximizing their bioavailability and therapeutic effects.

IQcafé is not just a beverage, but a synergy of bioactive compounds designed to elevate the coffee experience to a new level, where science and nature work in perfect harmony to empower the mind and body. Each cup of this intelligent coffee has been precisely formulated to optimize cognitive performance, improve stress response, stimulate sustained energy, and protect long-term brain health. Its composition is no coincidence; Each ingredient has been selected based on the latest scientific evidence, ensuring a perfect balance between effectiveness and bioavailability.

Its formulation includes adaptogens, natural compounds that increase the body's ability to adapt to situations of stress and fatigue without inducing unwanted side effects. Among them is Ashwagandha at a concentration of 200-300 mg per dose, a powerful cortisol regulator that balances the stress response and improves mental clarity, allowing the brain to function more efficiently without the wear and tear caused by overstimulation. Along with this, Rhodiola rosea at doses of 150-250 mg is recognized for its ability to reduce mental fatigue and improve memory, providing superior resistance to daily demands without compromising mood or generating residual fatigue.

Furthermore, IQcafé is an unparalleled source of antioxidants, those cellular guardians that combat oxidative stress, protect neurons, and delay brain aging. Among them, coffee polyphenols, in optimal concentrations derived from the bean itself, strengthen the body's natural defenses while enhancing cognitive function. Added to these are cocoa flavonoids, incorporated in proportions of 200-400 mg per dose, which have been shown to improve cerebral circulation and optimize oxygenation of neuronal tissue, promoting sustained alertness and greater focus. As a synergistic complement, green tea catechins, in concentrations of 150-300 mg, enhance neurogenesis and reduce inflammation in the nervous system, optimizing neuronal connectivity and improving information processing.

The brain cannot function at its peak capacity without the essential minerals that regulate its biochemical processes. Therefore, IQcafé has been enriched with zinc at a dose of 8-12 mg, a key trace element in synaptic plasticity, the formation of new neuronal connections, and the stability of the immune system. Complementing its action, copper, at a concentration of 0.9-1.2 mg, is essential for the production of neurotransmitters such as dopamine and norepinephrine, which are responsible for mood, motivation, and mental clarity. These minerals work together to enhance neuroelectrical activity and ensure optimal nervous system function.

To further enhance the smart coffee experience, powerful neurochemical modulators have been integrated that fine-tune cognitive processes and ensure a balanced state of alertness without the overstimulation caused by traditional stimulants. L-theanine, extracted from green tea and dosed at 100-200 mg, exerts a modulating effect on caffeine, reducing anxiety and promoting the production of alpha waves in the brain, a mental state associated with focused relaxation and fluid creativity. In turn, Coenzyme Q10 in amounts of 50-100 mg improves energy production in brain mitochondria, promoting prolonged cognitive performance without causing abrupt energy drops.

In addition, IQcafé contains bioactive compounds that optimize energy metabolism and enhance neuroplasticity. Medium-chain triglycerides (MCTs) from coconut, present at a concentration of 3-5 g per dose, provide rapidly absorbed energy for the brain, avoiding the peaks and drops that characterize other types of metabolic fuels. Its inclusion ensures a constant supply of energy without affecting blood glucose levels, promoting a sustained state of alertness. Complementing this effect, phenylethylamine (PEA) from cocoa, in amounts of 10-30 mg, stimulates the production of dopamine and serotonin, promoting a positive mood, sharp focus, and a sense of overall well-being that transcends the simple act of drinking coffee.

But the true revolution in IQcafé lies in the integration of cutting-edge compounds designed to enhance longevity and optimize cellular function at all levels. Among them is NAD+, an essential cofactor in mitochondrial energy production and DNA repair, whose impact on cellular vitality is comparable to the difference between a fine-tuned engine and one worn out by time. Its presence in the body decreases with age, but its restoration has demonstrated profound effects on tissue regeneration and the maintenance of optimal brain function. In line with this mechanism, resveratrol, a molecule extracted from grapes and red wine, amplifies the activation of sirtuins, key proteins in the regulation of cellular aging and metabolic longevity, strengthening the body's resistance to stress and promoting superior physiological balance. Alpha-ketoglutarate (AKG), another strategic ingredient, acts as a powerful intermediary in the Krebs cycle, promoting ATP production and improving cellular energy efficiency. Its role in collagen synthesis and optimizing bone and muscle metabolism make it an indispensable element for those seeking sustained physical and cognitive performance. These compounds not only work in the neurological sphere, but also extend their influence to the regulation of metabolism, the immune system, sexual function, digestion, blood circulation, and, ultimately, every area that determines the quality and length of life.

Each component of IQcafé has been carefully selected not only for its individual effectiveness, but for its ability to act synergistically with the others, generating a multiplying effect that optimizes the consumer experience. It is not just a beverage, but an intelligent nutritional strategy designed for those seeking to enhance their mental and physical performance without sacrificing their well-being. With each sip, the body receives the perfect combination of science and nature, transforming the act of drinking coffee into a high-performance ritual for the modern mind.

The coffee extraction process has also been optimized through a temperature and pressure modulation system that allows for the efficient release of bioactive compounds without compromising the beverage's organoleptic properties. This system adjusts variables such as extraction speed and water ratio based on the profile of the selected capsule and the user's physiological parameters, ensuring that each cup has the optimal composition for their needs in real time. Furthermore, product traceability is guaranteed through a blockchain-based infrastructure, which certifies the quality and origin of the ingredients, offering consumers complete transparency about the production process and ensuring sustainable agricultural practices.

One of the most disruptive features of smart functional coffee is its integration with an advanced mobile app, which allows users to monitor and adjust their consumption based on scientific data. This app not only records consumption history and the effects of each formulation, but also offers personalized recommendations based on the user's metabolic trends and individual goals. Through predictive models, the system can anticipate moments of fatigue, optimize alertness before key activities, and suggest specific formulations to maximize cognitive and physical performance in different scenarios.

The impact of this invention transcends the individual consumer experience. Its development is aligned with the global trend toward personalized, data-driven nutrition, opening up new possibilities for the functional food industry. In the corporate context, smart functional coffee is presented as a revolutionary solution to improve employee productivity and well-being, enabling more efficient energy management and concentration throughout the workday. In the sports field, its potential to optimize muscle recovery and metabolic endurance positions it as an essential supplement for high-performance athletes. In the longevity sector, its ability to modulate inflammation and oxidative stress makes it a key tool in healthy aging strategies and the prevention of neurodegenerative diseases. From a market perspective, smart functional coffee not only responds to a growing demand for products that integrate science and well-being, in also sets a new standard in the functional beverage industry. Its approach based on artificial intelligence and personalization distinguishes it from any other existing offering, creating a completely new category within the coffee market. Through a communication strategy focused on innovation and its impact on health, this invention is positioned as a cutting-edge product that redefines the consumer's relationship with coffee, transforming it from a simple beverage into a tool for biological and cognitive optimization.

This is the future of coffee: a fusion of technology, science, and personalization that elevates each cup to a whole new level. A revolution in the way we understand the consumption of functional beverages, paving the way for a future where nutrition will be completely adaptive, intelligent, and oriented toward holistic well-being.

The smart coffee system is made up of different interconnected modules that allow for the optimization and personalization of coffee based on the individual needs of each consumer. The coffee can be produced in vacuum-packed granules for distribution in conventional markets, or in a personalized format, using biometric analysis to optimize the formulation in real time. The functional coffee capsules contain formulations designed to improve cognition, energy, and overall well-being, incorporating ingredients such as L-theanine, balanced caffeine, adaptogens (ashwagandha, rhodiola rosea), and antioxidants. A liposomal microencapsulation system allows for the controlled and efficient release of these compounds to maximize their absorption and effect on the body.

The smart coffee maker incorporates biometric sensors that analyze heart rate variability, galvanic skin response, and other biomarkers to adapt the coffee formulation to the user's needs. An artificial intelligence algorithm processes this data and adjusts the levels of caffeine and bioactive compounds in real time. A mobile app associated with the coffee maker allows the user to monitor their coffee consumption and receive personalized recommendations based on their physiological state and drinking habits.

To ensure the quality and authenticity of the ingredients used, the production system is supported by a blockchain-based traceability system. This system allows verification of the origin of the ingredients and their manufacturing process, providing transparency and security for the consumer. This invention falls within the field of nutrigenomics, biotechnology applied to functional foods, and artificial intelligence for the optimization of personalized nutrition. It is an advanced system and method for the production, personalization, and distribution of functional coffee based on the user's individual biometric parameters, integrating emerging technologies in biomedicine, materials science, and digital traceability.

This intelligent ecosystem encompasses everything from the initial coffee formulation to its dynamic personalization through the analysis of real-time physiological data. It combines advanced manufacturing methodologies, such as nanotechnology for the encapsulation of bioactive compounds, precision fermentation to improve the bioavailability of active ingredients, and the implementation of blockchain to ensure product traceability and authenticity throughout the supply chain.

The proposed system consists of two complementary approaches. First, the production of generic functional coffee, developing standardized formulations enriched with clinically supported bioactive compounds, aimed at optimizing specific physiological functions such as metabolic regulation, improved cognitive performance, cardiovascular protection, and immune support, among many others that we will mention throughout the text. Advanced biotechnology is used to improve the chemical stability of the active ingredients and their absorption into the body.

Second, the personalization of elite functional coffee is based on the collection and analysis of user biometric data through wearable physiological monitoring devices, such as smartwatches, skin biosensors, and smart rings. Parameters such as heart rate variability, glucose levels, sleep quality, and oxidative stress are assessed in real time. With the help of artificial intelligence and machine learning algorithms, dynamic metabolic profiles are generated that allow predicting the individual response to the different bioactive compounds present in coffee. The personalized formulation is optimized using biocompatibility and pharmacokinetic techniques, adjusting to the nutritional and health needs of the patient. drinker. Furthermore, it is integrated with smart dispensing systems that allow the extraction conditions and dosage of functional compounds to be modulated based on the user's characteristics. This production and distribution model redefines the concept of functional coffee, offering an innovative solution that combines biometric precision, cutting-edge technology, and advanced health optimization strategies based on scientific evidence.

Coffee consumption is one of the most deeply rooted practices worldwide, with a significant impact on human health and productivity. It has been widely documented that coffee's bioactive compounds, such as caffeine, polyphenols, and diterpenes, have beneficial effects on cognitive function, thermogenesis, fat oxidation, and the reduction of various chronic diseases, including neurodegenerative and metabolic diseases.

Throughout history, the preparation and consumption of coffee have evolved based on cultural preferences, advances in extraction methods, and discoveries about its pharmacological properties. However, coffee formulation has remained largely standardized, failing to consider interindividual differences in the physiological response to its components.

Several studies have shown that caffeine metabolism varies significantly between individuals due to genetic polymorphisms in genes such as CYP1A2 and ADORA2A, which influence caffeine sensitivity and its effects on blood pressure, sleep, and cognitive performance. Furthermore, factors such as gut microbiota, metabolic status, and stress levels influence the bioavailability and efficacy of coffee's bioactive compounds.

With the advent of emerging technologies in biometrics, artificial intelligence, and nutritional biotechnology, the possibility of designing functional coffee formulations optimized for each consumer based on their physiological parameters in real time has opened up. Advanced sensors integrated into wearable devices, such as smartwatches and transdermal biosensors, allow for the monitoring of key variables such as heart rate variability (HRV), glucose levels, brain activity, and inflammatory response. Artificial intelligence and machine learning have proven to be key tools for analyzing large volumes of biometric data and generating dynamic health profiles, enabling the creation of personalized smart coffee formulas. Furthermore, advances in nanotechnology and precision fermentation have improved the stability, bioavailability, and absorption of bioactive compounds in functional foods.

Despite these advances, there is currently no comprehensive system that combines these technologies for the accurate and scalable production and personalization of smart coffee. This invention addresses this need by developing an optimized ecosystem that redefines coffee formulation, manufacturing, and distribution based on individual biometric data, establishing a new paradigm in personalized nutrition and bio optimization of human performance.

The system we are proposing is composed of three main modules that work together to offer an interactive, or smart, coffee experience. Essentially, it results in a personalized experience based on well-studied and proven scientific data. The first is the biometric analysis module, which collects physiological data in real time through wearable devices, transdermal sensors, and laboratory tests. This module assesses key parameters such as metabolic rate, cortisol levels, caffeine sensitivity (CYP1A2), heart rate variability (HRV), gut microbiota, and oxidative stress biomarkers. Using artificial intelligence algorithms, all this information is processed to generate a personalized consumption profile, enabling precise adjustments to the coffee formulation, which we are proposing to patent.

The second module focuses on personalized formulation, using machine learning models to design coffee blends tailored to each user's specific needs. The formulation integrates carefully selected bioactive ingredients, such as adaptogens (ashwagandha, rhodiola, among many others), nootropics (L-theanine, choline, phosphatidylserine, for example), antioxidants (polyphenols, coenzyme Q10, among others), and prebiotics that optimize absorption and bioavailability. Furthermore, nanotechnology improves the solubility and stability of the bioactive compounds, ensuring a controlled and sustained release of their benefits.

The third module, focused on smart production and distribution, employs Automated manufacturing with processes such as precision fermentation and microencapsulation to maximize the potency and efficacy of ingredients. To ensure product traceability and authenticity, blockchain technology is implemented, allowing consumers to know the origin and processing of each coffee bean until its final delivery. Distribution options include whole bean, ground, instant, compatible capsules, and liquid concentrates, offering versatility for different lifestyles and consumption preferences.

This coffee ecosystem sets a new standard in personalized nutrition and biohacking, allowing consumers to optimize their physical and cognitive performance with the support of science and technology.

The invention is developed in two main production and distribution models, designed to offer different levels of customization and optimization based on consumer health needs. The first is the generic functional coffee production model, focused on formulating blends designed to improve specific health conditions, following an evidence-based approach. Its production follows standardized protocols that guarantee the stability, bioavailability, and efficacy of the added bioactive compounds. The formulations are segmented according to different general health and wellness needs. For metabolism and glycemic control, coffees enriched with glucose-modulating compounds such as chlorogenic acid, cinnamon, and berberine are developed, specifically designed for people with diabetes or insulin resistance. In the area of cardiovascular health and hypertension, the blends incorporate polyphenols, magnesium, theobromine, and natural nitrates to help regulate blood pressure.

To optimize athletic performance, the formulations include dosed caffeine, beta-alanine, L-citrulline, and electrolytes, enhancing endurance and muscle recovery. For cognitive and mental enhancement, nootropics such as L-theanine, phosphatidylserine, choline, and Bacopa monnieri extracts are added, improving concentration, memory, and neuroprotection. For hormonal balance and sexual health, the blends are enriched with maca, tribulus terrestris, and zinc, supporting hormone production and sexual function. Finally, for longevity and cellular optimization, compounds such as resveratrol, coenzyme Q10, curcumin, and NAD+ are incorporated, which contribute to cellular and mitochondrial repair.

Each formulation is based on clinical research supporting the effects of its ingredients on human physiology. Additionally, advanced techniques, such as microencapsulation, are used to enhance the absorption and bioavailability of bioactive compounds, ensuring that the consumer obtains the maximum benefit from each cup of coffee consumed.

The formulations are also designed to address various health, wellness, and overall life-enhancing needs, always within a very broad spectrum, which could include any substance that has been previously studied and approved for use in humans and under no circumstances would be used otherwise. We now list some of these examples. For metabolism and glycemic control, coffees enriched with glucose-modulating compounds such as chlorogenic acid, cinnamon, and berberine have been developed, specifically for people with diabetes or insulin resistance. In the area of cardiovascular health and hypertension, blends with polyphenols, magnesium, theobromine, and natural nitrates are included, which promote blood pressure regulation. For those seeking to optimize athletic performance, combinations with dosed caffeine, beta-alanine, L-citrulline, and electrolytes have been formulated to improve endurance and muscle recovery.

In the area of cognitive and mental enhancement, the formulations include nootropics such as L-theanine, phosphatidylserine, choline, and Bacopa monnieri extracts, which contribute to improved concentration, memory, and neuroprotection. Sexual and hormonal health have also been considered in these blends, integrating ingredients such as maca, tribulus terrestris, and zinc, which help balance hormone production and improve sexual function. Additionally, the focus on longevity and cellular optimization has been realized in coffees enriched with resveratrol, coenzyme Q10, curcumin, and NAD+, which promote cellular and mitochondrial repair.

Each formulation is based on clinical research supporting the effects of its ingredients on human physiology. To maximize their effectiveness, advanced techniques such as microencapsulation are employed, which improves the absorption and bioavailability of the bioactive compounds. This innovation not only guarantees It not only offers a product with a high impact on the health and well-being of consumers, but also marks a significant advance in the application of science to functional coffee consumption.

The personalized smart coffee model represents the evolution of functional coffee toward a perspective of extreme personalization, integrating biometric technology, artificial intelligence, and molecular precision production. To achieve this, biometric monitoring devices are used to collect real-time data using wearables, transdermal sensors, and biochemical tests. These devices allow the evaluation of key parameters such as caffeine metabolism and tolerance through the analysis of genetic polymorphisms in CYP1A2 and caffeine oxidation biomarkers. In addition, neurocognitive status and alertness are analyzed by evaluating brain waves through wearable EEG and measuring key neurotransmitters.

Another key aspect is the study of the gut microbiota, which is carried out through the analysis of metabolites and bacterial diversity to determine the optimal prebiotic synergy in coffee. Likewise, circadian rhythms and oxidative stress are monitored through the measurement of cortisol, melatonin, and inflammatory markers, allowing the coffee formulation to be adjusted based on the user's biological cycle.

To process this information and generate precise recommendations, an artificial intelligence platform is implemented that analyzes biometric data and adapts the coffee formulation based on each user's physiological evolution. This platform is complemented by a mobile app, which allows users to receive personalized coffee profile updates according to their lifestyle and health goals.

These blends are produced on-demand with molecular precision, adjusting each batch based on detected metabolic and biochemical variations. To ensure the stability and efficacy of the active ingredients, advanced precision fermentation techniques and nanotechnology are applied.

Another key advancement in this ecosystem is the integration with smart coffee machines, conceived in this case in the patent application. These machines would be equipped with sensors that detect variables such as temperature, pressure, and concentration of active compounds, optimizing the extraction and preservation of the coffee's functional principles. They also feature connectivity with the mobile app, allowing the preparation of each cup to be adjusted based on the user's individual requirements. The combination of these elements establishes an innovative ecosystem in the field of functional coffee, merging personalized nutrition, advanced technology, and human performance optimization at different levels.

As we have discussed, the present invention is based on an interconnected ecosystem of hardware and software that enables real-time monitoring, analysis, and personalization of functional coffee formulations. To achieve this, a set of advanced devices designed to collect physiological and biochemical data from the user are integrated, optimizing the coffee drinking experience based on individual conditions.

The system includes a variety of biometric monitoring devices, such as smartwatches and biometric rings equipped with optical and electrical sensors. These wearables allow for continuous measurement of key variables such as heart rate, heart rate variability (HRV), sleep quality, physical activity, and more. Skin sensors and transdermal biosensors are also employed, which use bio impedance spectroscopy and electrochemistry to assess glucose, lactate, dermal pH, and skin conductance levels, providing accurate analysis of metabolism and stress levels.

In addition, specialized devices for biological fluid analysis are incorporated, capable of detecting biomarkers in sweat, saliva, and interstitial fluids. These sensors provide real-time data on cortisol, melatonin, dopamine, and serotonin, allowing formulations to be adjusted based on neurocognitive status and circadian rhythms. Continuous glucose monitoring (CGM) technology is also part of the system, ensuring accurate monitoring of blood glucose levels and optimizing formulations for consumers with insulin resistance or diabetes. For a more in-depth analysis of cognitive status, portable EEG devices are integrated, capable of measuring brain electrical activity. With this information, it is possible to adapt the coffee formulation according to the user's levels of alertness, concentration, and cognitive fatigue.

Among the biometric parameters evaluated are: Heart rate and heart rate variability (HRV), key indicators of the autonomic balance between the sympathetic and parasympathetic systems, are also analyzed. Sleep quality and architecture are also analyzed by studying sleep phases, efficiency, and latency using accelerometry and photoplethysmography (PPG).

Energy metabolism monitoring allows for the assessment of basal metabolic rate, caloric consumption, and response to caffeine according to the user's genetics, particularly in relation to the CYP1A2 gene. Measurements of glucose levels and insulin response are included to assess carbohydrate tolerance and the effects of coffee on glycemic homeostasis. This may also influence weight gain or loss in individuals.

In addition, hormonal markers such as cortisol, testosterone, estrogen, and melatonin are analyzed, allowing formulations to be adjusted according to each individual's hormonal status. The impact of oxidative stress and inflammation is also measured by evaluating the relationship between reactive oxygen species (ROS) and endogenous antioxidant systems, such as glutathione, superoxide dismutase (SOD), and catalase.

This advanced biometric monitoring system enables precision customization of functional coffee, dynamically adjusting it to the user's physiological conditions. This promotes a scientific approach to healthy longevity and optimal performance, integrating technology and personalized nutrition into a revolutionary consumer experience.

If we have followed the steps outlined above, we will realize that the patent proposal must include an advanced artificial intelligence platform integrated with a mobile application designed for the real-time collection, analysis, and customization of functional coffee formulations. This technology allows integration with biometric devices through secure wireless connectivity protocols such as Bluetooth Low Energy, Wi-Fi, and NFC, ensuring continuous collection of physiological and biochemical data. The platform analyzes this data in real time and synchronizes it with medical databases and reference physiological models to assess the coffee's compatibility with the user's health status.

The system employs machine learning algorithms, including deep neural networks, to identify physiological patterns and optimize formulations based on the user's metabolic response. Using supervised and unsupervised learning models, artificial intelligence dynamically adjusts the coffee's composition, ensuring progressive adaptation to the consumer's evolving health status. Additionally, expert systems based on biomedical ontologies are implemented to interpret the interaction between coffee's active ingredients and individual biomarkers, ensuring a precise and personalized formulation.

Using advanced anomaly detection mechanisms and predictive alerts, the platform identifies specific metabolic sensitivities, such as slow caffeine metabolism in individuals with genetic variants affecting CYP1A2 expression. Formulation customization adapts to different factors, including age and life stage, adjusting the coffee's composition to the metabolic requirements of each phase. It also allows for the optimization of specific functions such as cardiovascular health, liver function, neuronal metabolism, hormonal balance, and immune response.

In addition, the system considers the presence of chronic medical conditions, such as diabetes, hypertension, metabolic syndrome, neurodegenerative diseases, and sleep disorders, adjusting formulations accordingly. For those seeking to improve their cognitive performance, artificial intelligence adapts coffee based on neurophysiological metrics such as cortical activation, response latency, and executive processing, thus optimizing its impact on brain function. It also enables the modulation of neurochemical states by formulating specific ingredients that influence key neurotransmitters such as dopamine, serotonin, and acetylcholine, using a predictive approach based on brain biofeedback. Therefore, it is entirely feasible to understand the physiological parameters of each individual, which can be used to detect neurodegenerative diseases and Alzheimer's disease very early, providing a viable way to curb their spread in today's society.

This artificial intelligence technology applied to functional coffee personalization combines scientific rigor with precision biotechnology, offering a highly adaptive experience that The health, well-being, and performance of the user, effectively facilitating a healthy longevity within everyone's reach, simply through the pleasure of a good cup of coffee.

The intelligent coffee production system of the present invention integrates nanotechnology, precision fermentation biotechnology, and molecular optimization to ensure maximum bioavailability and effectiveness of the active ingredients incorporated into each formulation. Through the use of lipid nanocapsules and biodegradable polymeric micro particles, the stability and absorption of bioactive compounds such as polyphenols, alkaloids, and adaptogens are improved. Nanoemulsification technology optimizes the solubility of lipophilic compounds such as Coenzyme Q10, ensuring their absorption at the cellular level. Furthermore, precision fermentation using specific microbial cultures enhances the bioactivity of the ingredients, breaks down antinutrients, and increases the production of metabolites with neuroprotective and cardioprotective effects. Through enzymatic biotransformation processes, the structures of polyphenols and alkaloids are modified to optimize their impact on the modulation of the gut-brain axis.

The system incorporates an advanced database of functional ingredients, integrating a biomedical data management system with a catalog based on scientific evidence. It includes adaptogens such as Ashwagandha, Rhodiola rosea, and Siberian Ginseng; natural nootropics such as theanine, Bacopa monnieri, and Huperzine A; essential minerals such as zinc, copper, magnesium, and selenium; and antioxidant and mitochondrial compounds such as Coenzyme Q10, alpha lipoic acid, and flavonoids from cocoa and green tea, to name just the most widely used. Using artificial intelligence algorithms, ingredients are classified and combined based on the user's biometric profile and biochemical compatibility, ensuring highly personalized formulations.

The system allows for the generation of personalized blends with molecular precision, formulated based on individualized data obtained from biometric devices and genetic profiles. Through predictive pharmacokinetic and pharmacodynamic models, the ratios of active compounds are dynamically adjusted. Furthermore, real-time molecularly imprinted production of key ingredients enhances the stability and biological efficacy of each formulation.

The final product is available in various versions, including dry granulated coffee with highly bioavailable functional micronutrients, instant coffee optimized through freeze-drying to preserve polyphenols and antioxidants, coffee machine-compatible capsules designed for specific health formulations, and capsules diluted in virgin coconut milk, enriched with medium-chain triglycerides to enhance the absorption of fat-soluble compounds such as Coenzyme Q10 and flavonoids.

Each formulation incorporates key functional ingredients that optimize health and cognitive performance. Coenzyme Q10 acts as a mitochondrial enhancer with neuroprotective and cardioprotective properties, while Ashwagandha contributes to stress reduction and cortisol modulation. Rhodiola rosea improves resistance to oxidative stress and cognitive performance, while zinc and copper play essential roles in immune, antioxidant, and neuromodulatory function.

This system ensures a precision nutrition approach, optimizing the smart coffee formulation to suit individual needs, improve the bioavailability of active compounds, and maximize consumer health benefits.

The personalized functional coffee distribution system integrates advanced technologies to ensure authenticity, safety, and optimized consumption. Through blockchain-based traceability methods, smart packaging with real-time access to information, and an efficient distribution model, each user is ensured to receive a product tailored to their specific needs.

To achieve full traceability, a decentralized record system is implemented that documents every stage of the production process, from ingredient selection to final delivery. Through the use of smart contracts, the origin, authenticity, and quality of the bioactive compounds used in the formulation are verified. This ensures complete transparency, allowing both consumers and regulatory authorities to track detailed information about the origin of ingredients, manufacturing processes, and compliance with safety standards. Unique batch identifiers are also incorporated, storing data on the product's production and biochemical characteristics, tailored to individual user requirements. maximizes The product's packaging integrates smart technology through NFC tags and QR codes, offering immediate access to detailed information on the product's composition, nutritional profile, and personalized recommendations. Through a mobile app, users can view real-time data about their coffee, receive update alerts, and adjust customization settings based on their health status. To ensure product integrity during transport, RFID microchips are embedded in the packaging, allowing for continuous monitoring of temperature and environmental conditions. Biodegradable and sustainable packaging is also designed with sensors that indicate the coffee's freshness level, ensuring that the coffee is consumed at its optimal state.

The distribution system is complemented by a direct-to-consumer shipping model, based on logistics optimization algorithms that guarantee efficient and rapid delivery, whether through subscription or on-demand orders. Each user receives a personalized consumption protocol, designed according to their physiological needs and considering factors such as circadian rhythm, individual metabolism, specific health conditions, nutritional requirements, compatibility with other supplements or medications, and dose modulation based on the evolution of their biomarkers. To optimize the experience, artificial intelligence is integrated into the process of analyzing the user's response to functional coffee, adjusting future recommendations to achieve continuous product optimization. Additionally, a digital feedback model is established where the user can record the perceived effects and receive personalized adjustments to their next formulation.

This distribution approach ensures a constant personalization cycle, in which each batch of functional coffee evolves based on the user's biometric response, maximizing its impact on health and well-being. The personalized functional coffee ecosystem is complemented by smart coffee machines, designed to optimize coffee extraction, dosing, and brewing based on the bioactive composition of each formulation. These units, focused on elite groups, incorporate advanced sensors, IoT connectivity, and dynamic adjustment algorithms that maximize the bioavailability of functional compounds, adapting to the specific needs of each user.

Smart coffee machines, both domestic and commercial, feature spectroscopy and chemical analysis sensors that identify the exact composition of the coffee and automatically adjust the temperature, pressure, and extraction time to optimize its bioactive profile. Integrated with an artificial intelligence platform, these units personalize coffee preparation in real time, based on the user's recent biometric data. Furthermore, their compatibility with health monitoring systems allows the coffee's intensity and functional profile to be adapted according to the consumer's circadian rhythms, metabolism, and individual needs.

To preserve the stability of the most heat-sensitive ingredients, these machines precisely modulate the extraction of bioactive compounds such as adaptogens, antioxidants, and nootropics through controlled infusion processes. They also incorporate advanced emulsification technology that optimizes the dissolution of lipophilic compounds, such as Coenzyme Q10 and Rhodiola rosea extracts, ensuring efficient absorption in liquid preparations.

The system, in general terms, as we have detailed so far, is fully compatible with functional capsules and custom ground coffee. Through NFC and RFID technology, the machines identify the exact formulation of each capsule or coffee container, automatically applying the appropriate preparation parameters. Its adaptable extraction mode allows it to work with capsule coffee, ground coffee, or instant powder formulations, always ensuring maximum bioavailability of the active ingredients.

The smart user interface, connected to the mobile app, allows the consumer to select preferences for strength, temperature, and flavor profile, in addition to receiving recommendations based on their physiological state. These units also feature a modular dosing system that allows for combining different formulations depending on the time of day, physical activity, or the user's mood, providing a highly personalized drinking experience.

Thanks to this synergy between advanced technology and biometric personalization, the drinking experience is transformed into an optimized and exclusive process, where each functional cup of coffee is precisely tailored to the user's individual needs, maximizing its impact on health and well-being. tar.

The present invention introduces a comprehensive functional coffee personalization system based on biometric data, establishing a new paradigm in the coffee industry through the application of cutting-edge technologies. Its revolutionary approach combines artificial intelligence, nanotechnology, and biotechnology to offer a highly optimized and personalized drinking experience.

This system integrates real-time monitoring devices, such as smartwatches, biometric rings, and skin sensors, to collect detailed information about the user's physiology. Data such as heart rate, heart rate variability (HRV), sleep quality, metabolism, hormone levels, and stress are analyzed using advanced machine learning algorithms. With this information, the coffee formulation is dynamically adjusted to optimize its impact on energy, cognitive performance, and overall well-being.

Artificial intelligence plays a key role in functional coffee personalization. Through deep learning models, consumption patterns are correlated with health and cognitive performance metrics, enabling precise adjustments in nutrient profiles and bioactive compounds according to the user's changing needs. Furthermore, trained neural networks predict the physiological response to different combinations of ingredients, ensuring an optimized consumption experience based on scientific evidence.

To maximize the absorption and stability of bioactive compounds, this innovation incorporates nanotechnology into its formulations. The use of lipid nanocapsules and polymeric nanoparticles enables efficient delivery of antioxidants, adaptogens, and nootropics into the body. Furthermore, nanoemulsification technology improves the absorption of lipophilic compounds such as Coenzyme Q10 and polyphenols from cocoa and green tea, enhancing their effects at the cellular level.

Controlled fermentation with specific microorganisms elevates the bioactive profile of coffee, optimizing the production of phenolic acids, flavonoids, and prebiotic compounds. Through the development of selected bacterial and fungal strains, the positive effects on the intestinal microbiota are enhanced, promoting optimal digestive health. Furthermore, real-time metabolomic profiling ensures that each production batch contains the maximum expression of beneficial compounds. This synergy between advanced technology and biometric personalization redefines the concept of functional coffee, transforming it into a tool for optimizing well-being, cognitive performance, and longevity.

Functional coffee is diversified into specialized formulations based on scientific evidence, designed to optimize specific physiological parameters and enhance health and well-being. Each variant is conceived to address specific needs, maximizing its impact on quality of life and longevity.

To improve metabolic health, certain formulations incorporate polyphenols from cocoa and green tea, which promote glycemic response, along with cinnamaldehyde from cinnamon, recognized for its modulating effect on glucose, and chlorogenic acid from coffee, whose antidiabetic action has been widely documented. In the cardiovascular field, compounds such as nitric oxide from beetroot and citrulline, essential for vasodilation, are included. Resveratrol from red wine, with protective properties for blood vessels; and bioactive peptides from fermented coffee, which improve arterial elasticity.

Cognitive performance is enhanced by ingredients that modulate neurotransmitters and protect brain function. L-theanine from green tea improves concentration without inducing nervousness, while choline and phosphatidylserine are essential for memory and learning. Extracts of Rhodiola rosea and Bacopa monnieri complement this formulation, combating mental fatigue and optimizing focus.

In the area of longevity and cellular well-being, compounds have been integrated that activate antioxidant pathways and reduce oxidative stress. Coenzyme Q10 and PQQ promote mitochondrial function, while curcumin and quercetin stand out for their anti-inflammatory and anti-aging properties. Furthermore, the EGCG from green tea stimulates autophagy and cellular regeneration processes, contributing to the preservation of long-term vitality.

Hormonal balance is also a key aspect of these formulations. Adaptogens such as ashwagandha and maca regulate cortisol and mitigate stress, while tribulus terrestris and zinc promote optimal testosterone levels. For estrogen balance, soy isoflavones and flaxseed lignans are incorporated, with beneficial effects on hormonal regulation.

Beyond this with these approaches, functional coffee also adapts to other essential parameters for quality of life and longevity. The gut microbiota benefits from formulations enriched with prebiotics and postbiotics, while the immune system receives a boost through beta-glucans and reishi. For muscle regeneration, blends with BCAAs and collagen peptides are included, and to improve sleep, ingredients such as magnesium, GABA, and L-tryptophan promote optimal nighttime recovery. This approach to customization allows consumers to choose a coffee aligned with their individual needs, integrating science and well-being into every cup.

The evolution of functional coffee is not only based on the selection of ingredients with high biological value, but also on the ability to adapt and customize in real time. Through an on-demand production model with dynamically adjusted formulas, unprecedented optimization is achieved in the creation of blends designed to respond to the individual needs of each consumer.

The implementation of advanced flexible manufacturing systems enables automated production capable of generating customized blends instantly. This approach enables immediate adjustments to the coffee composition according to each user's specific requirements, optimizing production efficiency and reducing waste. Furthermore, the system's scalability ensures a swift and precise response to market demand.

The use of generative artificial intelligence models introduces a new level of personalization by enabling dynamic adjustments to formulations based on constantly evolving biometric data. Through continuous analysis of health parameters, the proportions of active ingredients are modified to maximize their benefits. This adaptive learning optimizes blends based on consumption patterns and observed effects, enabling predictive personalization that adjusts to both individual and population trends.

To ensure maximum efficacy in every cup, micro-dosing technologies for active ingredients are incorporated, ensuring molecular precision in each batch of coffee. This level of control allows for the precise incorporation of bioactive compounds, optimizing their absorption and effect. Furthermore, chemical stability and homogeneous distribution of ingredients are maintained, with rigorous quality control supported by advanced calibration processes. This production model redefines the functional coffee experience, integrating technological innovation with personalized wellness. The combination of automation, artificial intelligence, and micro dosing offers an adaptive, efficient, and scientifically supported solution, elevating the concept of functional coffee to a new level of sophistication and precision.

The integrated ecosystem of hardware, software, and custom manufacturing represents an unprecedented advancement in the evolution of this new food category created from functional coffee, combining cutting-edge technology with a highly personalized approach. This holistic environment encompasses the interconnection of biometric devices, artificial intelligence platforms, advanced manufacturing systems, and smart coffee machines, designed to deliver an optimized experience tailored to each user's individual needs.

The integration of biometric devices enables the continuous collection of physiological data, providing key insights into health and wellness parameters. This data is analyzed by artificial intelligence platforms and mobile applications, which adjust coffee formulations based on the user's condition and progress. At the same time, advanced production systems guarantee the precise manufacture of optimized functional coffee, ensuring the correct dosage of bioactive ingredients to maximize its benefits.

At the point of consumption, smart coffee machines take personalization to a new level, automatically adjusting brewing parameters according to the user's physiological profile and preferences. This synergy between hardware and software creates a unique experience, where each cup of coffee is optimized in real time to enhance health and well-being.

To ensure the traceability, authenticity, and quality of the final product, blockchain technology is implemented, providing an immutable record of every stage of the process, from ingredient selection to delivery to the consumer. This approach guarantees transparency and trust in each personalized blend.

The creation of an evolving consumption model allows the coffee to dynamically adapt to the user's health status, adjusting its properties based on their changing needs. This ensures a unique experience. of unprecedented personalization, in which functional coffee becomes a vehicle for wellness supported by scientific rigor and advances in biotechnology, artificial intelligence, and nanotechnology. The present invention establishes an automated workflow for the personalization of functional coffee, integrating real-time biometric data to ensure accuracy, optimization, and continuous adaptation to the user's needs. This process begins with the advanced capture of physiological parameters using biometric devices, which allow for continuous, real-time monitoring of key health indicators.

The user wears a smart device—which can be a watch, a ring, a skin patch, or even an implantable sensor—designed to collect detailed information about their physiological state. Recorded variables include heart rate and heart rate variability (HRV), offering a comprehensive view of the body's autonomic response and recovery. Sleep quality and stages are also analyzed, providing essential data on nighttime rest and regeneration. Blood glucose levels and basal metabolism are other factors assessed in real time, allowing for precise adaptation of bioactive ingredients based on the user's metabolic response. Additionally, hormonal biomarkers such as cortisol, testosterone, and estrogen are monitored, reflecting endocrine balance and its impact on energy, cognitive performance, and stress response.

In addition, allostatic load and stress levels, determining factors in the regulation of overall well-being, are analyzed. Other relevant parameters can be integrated based on the user's profile, ensuring that the functional coffee customization responds precisely and dynamically to their physiological needs and health goals.

The collected data is transmitted to a cloud-based artificial intelligence platform, where advanced algorithms process and analyze the information in real time. Through deep learning techniques, AI identifies complex patterns in biometric data and correlates them with specific nutritional and physiological needs. In addition, predictive health models are implemented that anticipate variations in the user's homeostasis, enabling proactive adjustments to the functional coffee formulation to optimize its impact. A multidimensional analysis simultaneously evaluates multiple biomarkers, integrating information on metabolism, hormone levels, sleep quality, stress response, and other key factors in overall health.

Based on this analysis, artificial intelligence generates a dynamic user profile, segmenting them according to their specific needs. This profile considers factors such as metabolic health, cognitive performance, longevity, and hormonal regulation, continuously adapting to offer a personalized and evolving recommendation aligned with individual wellness and biological optimization goals.

By processing biometric data, the system determines an optimized functional coffee formula for each user, selecting ingredients with specific benefits based on their individual needs. Key compounds include adaptogens such as ashwagandha and Rhodiola rosea, recognized for their ability to modulate stress and improve physical and mental resilience. Nootropics such as L-theanine, Bacopa monnieri, and Ginkgo biloba are also incorporated, which support concentration, memory, and cognitive performance.

In addition, powerful antioxidants such as cocoa polyphenols and green tea flavonoids are integrated, which combat oxidative stress and promote cellular longevity. Essential minerals, including zinc, copper, and magnesium, are incorporated to ensure optimal balance in metabolic and neurological functions. The system also adds coenzymes and active metabolites, such as coenzyme Q10 and NAD+, essential for cellular energy production and metabolic optimization.

The ratio of each of these compounds is precisely adjusted according to the user's progress, ensuring a dynamic formulation that continuously adapts to their health and well-being.

Once the personalized formula is defined, the information is securely transmitted to a manufacturing facility specializing in functional coffee. This process ensures that each blend is made precisely and in strict compliance with the parameters established by the artificial intelligence system.

Blockchain technology is implemented to ensure authenticity, quality control, and transparency throughout the production chain. This tool enables traceability. The entire process of each formulation, from ingredient selection to the final product, offers the user the certainty that their coffee has been manufactured with the highest standards of safety and efficacy. To maximize the absorption and efficacy of bioactive compounds, advanced processes based on nanotechnology and precision fermentation are incorporated. The use of lipid nanocapsules improves the solubility and bioavailability of lipophilic ingredients such as Coenzyme Q10, optimizing their effect on the body.

Likewise, the nanoemulsification of polyphenols and flavonoids facilitates their absorption in the digestive tract, enhancing their antioxidant benefits. At the same time, precision fermentation, using selected strains of microorganisms, optimizes the production of bioactive metabolites in coffee, improving its nutritional and functional profile. This innovative approach guarantees greater efficacy in every cup, ensuring that the consumer obtains the maximum benefit from each compound present in the formulation. Personalized functional coffee is processed at the production facility under strict quality controls, ensuring that each batch meets the highest standards of purity and efficacy. Different formats are available to suit consumer preferences and needs, including dry granulated coffee, optimized instant coffee, coffee machine-compatible capsules, and virgin coconut milk capsules enriched with supplements.

Each stage of production is recorded in a blockchain system, guaranteeing full traceability from the initial formulation to final delivery to the user. This system provides authenticity and transparency, ensuring that each personalized blend retains its integrity and exact composition. Once processed, the coffee is shipped directly to the consumer along with a QR or NFC code, allowing access to their personalized profile and specific drinking recommendations.

If the user has a smart coffee machine, this technology enables a completely optimized brewing experience. Through IoT connectivity and QR or NFC code reading, the machine recognizes the coffee's unique formulation and automatically adjusts key parameters, such as temperature, pressure, and extraction time, ensuring maximum release and bioavailability of bioactive compounds.

Furthermore, the machine collects consumption data and integrates it into the artificial intelligence platform, enabling continuous analysis and future optimizations in the coffee formulation. In this way, each cup adapts not only to the user's current needs but also contributes to the evolution of their personalized profile, enhancing their well-being over time. The continuous optimization system ensures that the personalization of functional coffee evolves in sync with the user's needs. Artificial intelligence analyzes the body's response after consumption in real time, evaluating changes in biometric parameters, feedback on perceived well-being, and data correlation over time.

Based on this information, the system dynamically adjusts future formulations, ensuring progressive improvement in product adaptation. This approach integrates biotechnology, artificial intelligence, and nanotechnology to turn coffee into an adaptive health vehicle, optimizing not only the user experience but also their long-term well-being.

Smart functional coffee is not simply an evolution of traditional coffee, but a radical transformation of its role in people's daily lives. Its integration of advanced technology, biotechnology, and personalization positions it as a revolutionary product with applications ranging from individual consumption to wellness strategies in corporate, sports, and clinical settings. Its versatility and adaptability to different needs make it an essential element in the functional nutrition of the future.

For home and personalized consumption, this invention redefines the coffee drinking experience by offering a formulation adapted in real time to the user's physiological conditions. Supported by biometric sensors and artificial intelligence algorithms, each cup becomes a biological optimization tool, adjusting levels of caffeine, adaptogens, and nootropics according to the consumer's metabolic and emotional state. This personalization not only enhances the sensory experience but also maximizes the benefits of coffee in terms of energy, concentration, relaxation, and recovery. Through its integration with a mobile app, users can monitor their consumption, receive recommendations, and adjust formulations to achieve their wellness goals. Activity or physical and mental performance.

In the corporate world, smart functional coffee represents an innovative solution within organizational wellness programs. Companies are increasingly seeking strategies to improve the health and performance of their employees, and this technology offers a direct response to that need. By providing coffee optimized for each individual, the negative effects of stress and fatigue can be reduced, concentration increased, and work efficiency improved. Its integration with health monitoring systems allows organizations to analyze consumption trends and design personalized strategies to optimize their teams' performance. From break rooms to smart coffee stations in workspaces, this product transforms coffee into a strategic tool for productivity and well-being in the corporate environment.

High-performance athletes and professionals find smart functional coffee a key ally for optimizing physical and mental performance. Its specialized formulation can boost endurance, improve muscle recovery, and regulate cortisol levels, promoting optimal physiological balance. Thanks to liposomal microencapsulation and precise modulation of bioactive compound extraction, key ingredients are absorbed more efficiently, ensuring that each cup provides maximum impact in terms of sustained energy, muscle recovery, and mental focus. Furthermore, its ability to integrate with monitoring devices allows athletes to adjust their consumption according to the specific demands of each training or competition, ensuring optimized preparation and recovery.

In clinical and healthcare contexts, smart functional coffee opens up new possibilities in personalized nutrition and preventative medicine. Its ability to modulate coffee's impact based on individual biomarkers makes it a powerful tool for managing conditions such as chronic stress, fatigue, sleep disorders, and neuroprotection against degenerative diseases. Clinics and healthcare centers can utilize this technology to offer their patients an innovative and scientifically supported approach to regulating well-being through functional nutrition. Furthermore, its integration with longevity and metabolic optimization programs allows for the development of personalized strategies to improve quality of life and prevent premature aging. Each of these applications represents a facet of the immense potential of smart functional coffee. Its combination of advanced science, cutting-edge technology, and personalization makes it a product that not only responds to current health and wellness trends, but redefines them, setting a precedent for smart and personalized nutrition, which will undoubtedly continue to advance as science and technology continue their constant development. With its implementation, coffee ceases to be a simple stimulant beverage and becomes a tool for holistic optimization, driving a new era in functional nutrition and the science of wellness.

Since its discovery, coffee has been a pillar of daily life for millions of people, a natural elixir that awakens the senses, boosts productivity, and fuels creativity. However, science advances, and with it, the need to transcend the boundaries of convention. The invention of smart coffee marks a turning point in the evolution of the consumption of this ancient beverage, integrating the principles of neuroscience, biotechnology, and functional nutrition to redefine the coffee experience and enhance its benefits to levels never before achieved.

For the first time in history, a beverage has been conceived with the explicit purpose of interacting with the human lifestyle and method of life, optimizing health in the broadest sense of the word and promoting healthy longevity. More than a simple stimulant, smart coffee aligns with advances in biohacking and epigenetics, integrating factors that directly influence genetic expression, neuroplasticity, and metabolic performance. In a world where technology and biology converge to expand the limits of human potential, this formulation opens a new era in which functional nutrition not only supports individual development, but also strategically drives it.

The synergy of active components in smart coffee transforms each cup into a tool for cognitive optimization. By integrating neuroprotective compounds, adaptogens and essential micronutrients, this formulation amplifies the brain's ability to process information, improve memory, strengthen It stimulates neuronal plasticity and elevates alertness without generating the side effects associated with excessive caffeine consumption. It thus becomes a modulator of brain function, promoting sustained and balanced performance, adapted to the challenges of modern life.

Each element in its composition has been carefully selected based on scientific evidence. The addition of zinc and copper contributes to the synthesis of key neurotransmitters, strengthening synaptic connections and optimizing neuronal communication. The combination with natural compounds such as ashwagandha and rhodiola rosea mitigates the impact of oxidative stress, reducing cortisol and stabilizing the nervous system. The result is a sensory and functional experience that enhances mental clarity and resistance to exhaustion.

Smart coffee is distinguished not only by its neurological benefits but also by its metabolic and epigenetic impact. The inclusion of green tea adds catechins with thermogenic and antioxidant properties, facilitating metabolic regulation and optimizing cellular energy production. Ground cocoa enriches the bioactive profile with theobromine and flavonoids, stimulating blood circulation and enhancing brain oxygenation. Dried ground coconut provides medium-chain triglycerides, an immediate source of energy that the brain metabolizes more efficiently than traditional carbohydrates.

The development of a capsule version compatible with the most advanced coffee machines and the functional instant coffee presentation guarantee practical and versatile access, adapted to the pace of contemporary lifestyles. Each smart coffee variant is designed to respond to different needs and preferences, allowing for a personalized experience without compromising the quality or purity of the ingredients.

In the field of longevity and holistic health, this invention represents a significant advance. The strategic combination of bioactive ingredients with neuroprotective, anti-inflammatory, and antioxidant properties not only maximizes brain function in the present, but also contributes to the prevention of long-term cognitive decline. Regular consumption becomes an investment in future well-being, supporting neuronal resilience and protecting the brain against the effects of aging. Smart coffee is not a simple evolution of traditional coffee; it is a revolution designed for those seeking more than a stimulating beverage, but a tool for optimizing their brains, bodies, and metabolism. It is the manifestation of a futuristic approach, based on science and technology, to transform the everyday act of drinking coffee into a ritual of peak performance. Along this path, functional coffee introduces new concepts and new visions, redefining the limits of what is possible in improving human life. As we explore the capabilities of the body and mind, this invention becomes a testament to the immense potential yet to be discovered.

Next, we will discuss one of the two variants of IQCoffee: The Non-Personalized variant, which can be found on the shelves of a wide variety of markets, both physical and online. This product is subdivided according to a series of general characteristics that people can choose according to their personal needs, without being comparable to the personalized variant, to which we have dedicated the majority of the information in this text. Without a doubt, it will represent a step forward compared to the coffees currently available in various markets. Coffee has evolved beyond its traditional essence to become a tool for well-being, and IQCoffee represents that transformation with a formulation designed to enhance daily life. This non-personalized variant would be available in two formats-vacuum-packed granules and dehydrated dry coffee-with this innovative blend, its active biological properties are maintained intact, guaranteeing an optimal experience with any preparation method.

The secret of IQCoffee lies in its meticulous production process. Its base is a selection of the highest-quality Arabica and Robusta coffee beans, subjected to a treatment that preserves the richness of their natural antioxidants and optimizes their absorption in the body. Carefully selected bioactive compounds are added to this base, such as adaptogens, nootropics, and essential nutrients that boost concentration, energy, digestion, and hormonal balance, among other specific benefits. The vacuum-packed granulated format ensures that every coffee particle retains its freshness and bioactive potency. Thanks to this storage method, premature oxidation is avoided. The added compounds are preserved, allowing their biological action to remain stable until the moment of consumption. When prepared in traditional drip coffee makers, espresso machines, or French presses, its ingredients are evenly integrated into the infusion without being degraded by heat or pressure, guaranteeing a sensory and functional experience in every cup.

The dehydrated dry format, meanwhile, undergoes an advanced freeze-drying process that retains all the coffee's properties and functional components without altering its molecular structure. This technology allows the bioactive compounds to be instantly reactivated upon contact with hot water, ensuring that each sip contains the maximum concentration of benefits. Its versatility makes it ideal for capsule coffee makers, instant coffee methods, and cold brews without compromising its impact on the body.

Unlike conventional coffee, which only provides caffeine, IQCoffee offers a complete wellness profile backed by science. Whether in its vacuum-packed granulated version or its dehydrated dry format, each cup is an invitation to experience coffee like never before: a fusion of flavor, technology, and health that adapts to modern life without sacrificing the quality or effectiveness of its active ingredients.

Imagine waking up every morning with the power to choose the energy you truly need. It's not just a coffee, but an experience designed to enhance every aspect of our lives. IQCoffee is not a simple stimulant; it's a wellness tool created with the precision of science and the pleasure of the senses. Every sip is an invitation to reach our best version, with formulas that respond to the demands of a world in constant motion. Below, we briefly describe the main non-personalized IQCoffee products that can be purchased at any online marketplace currently available anywhere in the world.

If you're looking for digestive harmony, IQCoffee Balanced Digestion is the perfect option. Its blend of high-quality Arabica coffee, ginger, cardamom, and natural prebiotics promotes intestinal health and soothes digestive discomfort. Each cup is a balm that stimulates the microbiota, reduces inflammation, and promotes light and efficient digestion.

For those who wish to defy the passage of time, IQCoffee Healthy Aging offers a combination of advanced antioxidants, coenzyme Q10, resveratrol, and turmeric with piperine. Its protective effect strengthens cell regeneration, optimizes cardiovascular health, and combats wear and tear, allowing each day to be an investment in longevity and vitality.

In a world saturated with distractions, mental clarity is a treasure. IQCoffee Concentration and Focus is formulated with L-theanine, Bacopa Monnieri, and Rhodiola Rosea, ingredients that enhance memory, reduce mental fatigue, and optimize neuronal connection. It is the perfect ally for those seeking precise thinking, boundless creativity, and unwavering concentration. For those who challenge their physical limits, IQCoffee Performance and Energy combines high-intensity robusta coffee with pure cocoa, creatine, and Cordyceps sinensis. Its formula boosts muscular endurance, improves oxygenation, and accelerates recovery after exertion, turning every workout into a path to peak performance.

Vitality is also measured in passion and balance. IQCoffee Hormonal Balance and Sexuality awakens internal energy with Peruvian maca, ashwagandha, and L-arginine. Their synergy promotes blood circulation, regulates hormones, and elevates libido, providing a natural boost for emotional well-being and intimate connection.

For those seeking deep rest without compromising clarity, IQCoffee Sleep and Relaxation offers a unique experience. Its Swiss Water decaffeination process preserves the essence of coffee, while valerian, passionflower, and magnesium bisglycinate induce restful sleep and balance the nervous system. Each cup is a whisper of tranquility that prepares the body and mind for a restorative rest.

In each of its versions, IQCoffee not only awakens the senses, but redefines the way coffee can transform lives. Each blend is a conscious choice, a step toward holistic well-being, and a commitment to excellence. It's not just coffee; it's the future of smart energy.

For centuries, coffee has been the driving force of brilliant minds, the daily ritual that awakens the senses and prepares the body for action. But science has gone further, transforming this beverage into a tool for total well-being. IQCoffee is the evolution of coffee, a perfect synergy between nature and technology that enhances human performance in all its dimensions. It's not just a cup of coffee. Faith is the fuel of a new era.

Each IQCoffee variant has been created to respond to the needs of a modern life, where coffee is not just a pleasure, but a tool for continuous improvement. For those seeking mental clarity and superior focus, IQCoffee Concentration and Focus offers a fusion of Bacopa Monnieri and L-theanine, designed to boost memory, sharpen thinking, and keep the mind at its peak performance. For those who need more energy without the highs and lows of traditional caffeine, IQCoffee Performance and Energy combines robusta coffee with creatine and Cordyceps sinensis, improving physical and mental endurance, increasing oxygenation, and optimizing recovery.

Well-being is not just a matter of immediate energy, but also of longevity. IQCoffee Healthy Aging is the answer for those who want to protect their long-term vitality with a blend of coenzyme Q10, resveratrol, and turmeric with piperine, ingredients that support cell regeneration and strengthen the cardiovascular system. And for those seeking digestive balance without sacrificing the pleasure of their daily coffee, IQCoffee Balanced Digestion incorporates ginger, cardamom, and natural prebiotics, promoting better nutrient absorption and preventing post-meal heaviness.

Holistic wellness also encompasses hormonal balance and connection with our vital energy. IQCoffee Hormonal and Sexual Balance combines Peruvian maca, ashwagandha, and L-arginine, ingredients that boost circulation, regulate hormones, and stimulate desire and vitality in all aspects of life. And for those who value rest as an essential part of their performance, IQCoffee Sleep and Relaxation reinvents the nighttime coffee experience with a decaffeinated formula treated with Swiss Water, enriched with valerian, passionflower, and magnesium bisglycinate, ensuring a deep and restful night's sleep.

Now, this revolution could be within everyone's reach. IQCoffee can reach traditional markets to offer a real and affordable alternative to conventional coffee, which only provides caffeine without additional benefits. It's not just about waking up, but about empowering every aspect of life with every cup. Discovering IQCoffee means choosing a coffee designed to enhance daily well-being and improve life in all its aspects. The future may be here when this new product is available on the shelves of the market closest to our homes.

IQCoffee could prove to be a catalyst for human transformation in multiple dimensions and achieve the goal of healthy longevity. Through its combination of active ingredients designed to optimize brain function, regulate metabolism, and improve body homeostasis, it could also become a key tool for creativity, concentration, physical and mental recovery, as well as for exploring advanced states of consciousness. Below, we present some representative examples of its potential impact in different scenarios to give you an idea of what could be achieved if the patent for the System and Method for the Production and Consumption of Intelligent Coffee (IQCoffee) is approved.

In the first case, we have a 42-year-old researcher dedicated to the study of theoretical physics who could face a series of health problems that would compromise his cognitive performance and overall well-being. If he were to suffer from diabetes and aggravated metabolic syndrome, with digestive problems and sexual dysfunction, this person could experience constant mental fatigue and marked difficulty maintaining concentration during intense work sessions. He could also seek to achieve deep states of relaxation and meditation to improve his mental clarity and creativity. Initially, the IQCoffee formulation could include caffeine combined with L-theanine in proportions designed to induce a balance between neuronal excitation and relaxation, stabilizing brain activity in alpha and theta waves. This initial version could allow you to experience a clearer state of mind, with improvements in stress management and a prolonged ability to focus. However, if after a month of consumption, it is identified that your metabolism is not processing glucose efficiently, a specific reformulation may be required.

The composition of IQCoffee could be adjusted by adding berberine, an alkaloid with regulatory effects on insulin sensitivity, as well as Ceylon cinnamon, known for its ability to stabilize blood glucose levels. In parallel, ginger and digestive enzymes could be introduced to improve nutrient absorption and alleviate digestive problems. These modifications could allow, in a small Over a two-month period, his glycemic profile would stabilize, reducing insulin spikes and significantly improving his daily energy.

As his metabolism improved, a third optimization phase could be added with ashwagandha and Peruvian maca, two adaptogens that would regulate his stress response and enhance endocrine function. These additions could have a positive impact on his hormonal balance, restoring his sexual health and strengthening his resistance to physical and mental exhaustion. With this final adjustment, he could maintain sustained performance in his research without experiencing the fatigue that had plagued him for years.

Over the course of six months, the evolution of his personalized IQCoffee could allow him to reach a level of physiological stability that would completely transform his intellectual performance and overall well-being. With a more focused mind, improved metabolic response, and a capacity for deep relaxation, he could significantly advance his research and explore new theoretical approaches with a mental clarity that had previously been unattainable. This case would exemplify how an adaptive formulation of IQCoffee could become a fundamental tool for the comprehensive optimization of human performance.

IQCoffee could also prove to be a revolutionary tool in optimizing cognitive performance and restoring physiological balance. Let's now analyze the hypothetical case of a 54-year-old businessman, trapped in a grueling routine of endless meetings and strategic decisions. The effects of chronic stress and mental exhaustion could become evident. If his constant travel around the world disrupted his circadian rhythm, severe insomnia could worsen, resulting in persistent fatigue, high triglyceride and cholesterol levels, and recurring chest tightness that would make him fear for his life. Panic attacks and the loss of his sexual potency could plunge him into a constant state of anxiety, affecting his leadership and decision-making abilities. The initial IQCoffee formulation for her case might combine sustained-release caffeine with L-theanine and Rhodiola rosea, with the goal of improving her stress resistance and stabilizing her cortisol levels. During the first few weeks, she might experience a temporary improvement in her energy and mental clarity, but if insomnia and chest tightness persist, her IQCoffee could be reformulated to incorporate magnesium, ashwagandha, and GABA, promoting more effective regulation of the autonomic nervous system and a progressive reduction of the sympathetic hyperactivity that fuels her panic episodes.

Over time, her metabolic system might begin to respond positively, reducing triglyceride and cholesterol levels thanks to the addition of cocoa polyphenols and bergamot extract to the formula. This could not only improve her lipid profile but also contribute to reducing systemic inflammation. As his body stabilized, Coenzyme Q10 and L-citrulline could be added, optimizing cardiovascular function and restoring his overall vitality. Within months, his resistance to stress could increase significantly, his sleep could be regulated naturally, and his sexual potency could be restored, allowing him to resume his life with renewed energy.

The process of continually adjusting the IQCoffee formulation based on his specific needs could be key to his transformation. What would begin as an attempt to stay alert during his work routine could eventually become a truly comprehensive recovery strategy, providing him not only mental clarity and sustained focus, but also a physiological stability that would redefine his quality of life.

IQCoffee could also work in extreme cases, such as a 65-year-old man who had suffered an ischemic stroke affecting key areas of his motor and language cortex, compromising his mobility and cognitive abilities. His ability to speak and remember would be impaired, and doctors would consider a full recovery unlikely due to the extent of the neuronal damage. To address this challenge, your recovery protocol could include a specific IQCoffee formulation designed to enhance neuroplasticity and long-term neuronal repair. The initial combination would contain caffeine and L-theanine, modulating brain activity to promote alertness without over-excitement, which could optimize concentration and facilitate motor rehabilitation. Additionally, bacopa monnieri and phosphatidylserine would be incorporated, two compounds with proven efficacy in improving memory and strengthening neuronal synapses.

During the first few weeks in this context, the activation of brain-derived neurotrophic factor (BDNF) would stimulate the formation of new synaptic connections, a crucial process in post-stroke recovery (Bekinschtein et al., 2011). However, to further enhance regeneration, their IQCoffee formulation would evolve, including citicoline and alpha-lipoic acid, both recognized for their effects on neuronal membrane restoration and the reduction of oxidative stress (Secades & Lorenzo, 2006).

As their mobility and language skills began to improve, their IQCoffee protocol could incorporate ginseng and rhodiola rosea, two adaptogens that promote neuronal resistance to stress and improve the regulation of the dopaminergic system, key to motivation and mood (Panossian & Wikman, 2010). At the same time, supplementation with DHA and Coenzyme Q10 would optimize mitochondrial function, ensuring an efficient energy supply for neurogenesis and cellular repair.

Over the course of a year, with an appropriate nutritional and rehabilitation strategy, their cognitive capacity could improve significantly, with a recovery of up to 85% of their mobility and verbal fluency. This process would demonstrate how an adaptive formulation of IQCoffee could play a crucial role in neuroregeneration, facilitating the recovery of patients with severe neurological conditions. This is a borderline case, but also probable due to the plasticity of the data platform that would comprise IQCoffee.

We could refer to countless hypothetical cases, as life is almost infinite in terms of possible variables. Since no case is similar to another, no matter how similar their circumstances, there is always something that distinguishes and personalizes each one. I am convinced that personalized functional medicine is emerging as the medicine of the future, where the focus will be on preventing people from getting sick. This makes perfect sense, as fewer people would need to be treated, making the process more humane and more cost-effective. Below, we continue to present some examples of approaches in which IQCoffee could play a very important role, focusing on various general aspects of human behavior, such as:

Emotional balance and longevity, something very in vogue these days and something that a significant portion of people on the planet are concerned about. Longevity would not depend solely on biology, but also on emotional health. To maintain a balance between body and mind, a daily protocol could be established that includes IQCoffee with green tea and ashwagandha. The combination of caffeine with L-theanine promotes concentration and prevents mental exhaustion, while ashwagandha regulates the HPA axis, reducing the negative effects of stress on the body. The epicatechin from the cocoa in the blend stimulates the production of BDNF, promoting neuroplasticity and helping maintain a youthful and resilient mind. Following this routine would lead to greater emotional stability, which would directly impact overall well-being. Fatigue would significantly decrease, and the ability to face life's challenges would improve, reflecting the positive effects of a holistic approach to the pursuit of full and conscious longevity.

The relationship between gut microbiota and overall health could be crucial for long-term well-being. For those facing digestive issues such as irritable bowel syndrome, a natural and effective solution could be found in the combination of IQCoffee with dried ground coconut and zinc. Coconut provides medium-chain triglycerides, easily metabolized without generating inflammation, and contains prebiotic fiber capable of nourishing the beneficial bacteria in the gut. Zinc contributes to the repair of the intestinal mucosa and strengthens the epithelial barrier, reducing permeability and preventing autoimmune responses.

Incorporating this beverage into your daily routine would result in improved digestion, a reduction in bloating, and more regular intestinal transit. This strategy, based on a balance between nutrition and intestinal function, would promote greater digestive stability and sustained well-being over time. Digestive well-being would largely depend on the balance between the gut and the nervous system. To address disorders such as intestinal dysbiosis, Crohn's disease, and ulcerative colitis, an effective strategy could include consuming IQCoffee with green tea, Rhodiola Rosea, and ashwagandha. This combination would provide stable energy while reducing intestinal inflammation and modulating the gut-brain axis. L-theanine is present in The antioxidant properties of green tea contribute to relaxation without causing sedation, decreasing the nervous system's response to stress, a key factor in digestive problems. Rhodiola rosea may help regulate cortisol levels, reducing the impact of stress on intestinal motility and preventing episodes of irritable bowel syndrome. Regular consumption of this blend may promote better food assimilation, reduce abdominal inflammation, and enhance a greater sense of overall well-being.

Endurance athletes often face digestive problems due to the frequent consumption of protein supplements and high-carbohydrate diets. To counteract these effects, incorporating IQCoffee with cocoa and zinc could represent an effective solution. Cocoa may promote the production of short-chain fatty acids in the gut, which would improve microbiota health and reduce inflammation. Zinc, for its part, may play a crucial role in the regeneration of the intestinal epithelium and the production of digestive enzymes, facilitating nutrient absorption. Regular consumption could reduce digestive discomfort during training, optimize the absorption of essential nutrients, and sustainably improve physical performance. Constant training requires strategies that maximize energy and accelerate recovery without compromising mental state. A combination of IQCoffee with dried ground coconut and zinc before morning sessions could provide a quick and sustained source of energy thanks to the medium-chain triglycerides in coconut. Caffeine, along with Coenzyme Q10, boosts mitochondrial capacity, improving both physical and mental endurance during prolonged training sessions. Green tea may help reduce inflammation after intense sessions, while Rhodiola Rosea may optimize oxygen utilization, promoting more efficient aerobic performance. By integrating this strategy into a biohacking protocol, one could experience less muscle fatigue and faster recovery, allowing for greater intensity training without compromising overall well-being.

The development of regenerative therapies requires sustained focus and optimal mental state. In this context, incorporating IQCoffee with cocoa and Coenzyme Q10 could represent an effective strategy for enhancing cognitive performance and resistance to mental fatigue. Cocoa stimulates nitric oxide production, promoting blood circulation and ensuring adequate brain oxygenation. Coenzyme Q10, in addition to improving mitochondrial efficiency, protects against oxidative damage and chronic inflammation, factors closely linked to aging. The synergy between caffeine and L-theanine allows for maintaining a state of deep concentration without causing mental fatigue. Regularly integrating this combination into your daily routine could lead to improvements in cognitive function and the ability to maintain a high level of productivity without compromising overall well-being.

The search for effective strategies to extend longevity and improve quality of life has led to the development of protocols based on scientifically supported habits. Within this approach, consuming IQCoffee with dried ground coconut, zinc, and Rhodiola Rosea could offer significant benefits for optimizing metabolism and preserving cognitive function. The medium-chain triglycerides present in coconut provide a stable and efficient source of energy, reducing dependence on glucose and promoting autophagy, an essential mechanism for cellular regeneration and maintenance. Zinc, by promoting DNA repair and strengthening the immune system, contributes to protection against premature aging. Rhodiola Rosea, meanwhile, could improve resistance to stress and preserve mental agility, reducing the impact of cognitive decline. With consistent application of this protocol, it would be possible to observe improvements in overall vitality, reflected in healthier skin, stronger joints, and an agile mind, challenging the conventional limits of biological age.

Healthy aging requires a preventative approach that prioritizes cellular optimization over disease treatment. Within this framework, consuming IQCoffee with green tea and Coenzyme Q10 could represent an effective strategy to improve mitochondrial function and mitigate the impact of oxidative stress, two determining factors in longevity. Coenzyme Q10 would promote the production of ATP, providing sustained energy levels and protecting cells against premature senescence. The catechins in green tea would act as potent antioxidants, reducing inflammation and for Strengthening the cardiovascular system. The combination with ashwagandha and Rhodiola Rosea may contribute to cortisol balance, minimizing the negative effects of chronic stress on the body. Implementing this strategy could lead to improvements in vitality and mental clarity, allowing for optimal physical and intellectual performance over the years.

Exploring the human mind and producing complex ideas would require a highly creative state of mind and prolonged concentration. To achieve this, a combination of IQCoffee with Coenzyme Q10 and cocoa could enhance brain bioenergetics, ensuring a constant and structured flow of ideas. The synergy between caffeine and L-theanine would promote states of deep concentration, minimizing distractions and avoiding adverse effects such as anxiety. Ashwagandha would contribute to emotional regulation, reducing stress and facilitating fluidity in the expression of ideas. By integrating this strategy into one's creative routine, one could experience fewer mental blocks and a greater ability to organize complex concepts, optimizing both the quality and depth of thought. Working in environments that demand high analytical skills and prolonged concentration requires strategies that optimize mental performance without causing fatigue. A combination of IQCoffee with green tea and cocoa can provide key benefits in this regard. The epicatechin present in cocoa stimulates neurogenesis and synaptic plasticity, promoting more efficient information processing. L-theanine modulates the effects of caffeine, avoiding peaks of arousal and promoting a state of relaxed attention that facilitates sustained work. Ashwagandha, a potent adaptogen, contributes to the regulation of cortisol levels, helping to manage pressure without affecting cognitive performance.

By integrating this blend into your daily routine, it is possible to reduce mental fatigue and improve the ability to solve complex problems without the need for extended breaks. Optimal performance in complex surgeries requires a precise balance between sustained energy, mental clarity, and stress management. A combination of IQCoffee with Coenzyme Q10 and Rhodiola Rosea can be key to maintaining a high level of concentration without causing fatigue. Coenzyme Q10 optimizes ATP production in cells, ensuring a constant flow of energy to the prefrontal cortex, a key region for decision-making and fine motor coordination. Rhodiola rosea modulates the stress response, promoting a state of calm focus during prolonged procedures. The combination of caffeine and L-theanine provides a sustained state of alertness without generating tremors or anxiety, allowing you to maintain the precision needed for each task. Incorporating this blend into your daily routine can promote mental clarity and reduce exhaustion at the end of the day, optimizing performance during demanding days.

The creative process requires a delicate balance between deep concentration and fluid intuition. For those seeking to achieve states of sustained inspiration, IQCoffee with cocoa, L-theanine, and ashwagandha can be a key tool. Cocoa, rich in epicatechins, stimulates neurogenesis and synaptic plasticity, enhancing the connection between ideas and facilitating the structure of complex concepts. L-theanine modulates the effects of caffeine, promoting a state of relaxed attention, ideal for creativity without mental blocks. Ashwagandha, an essential adaptogen, balances cortisol levels and reduces stress, allowing for a creative flow without emotional distractions. This synergy promotes a meditative and intuitive state of mind, typical of artists and thinkers who seek to transcend the conventional limits of the mind.

Every morning begins with a ritual: the first sip of coffee, that moment when the intense aroma awakens the senses and prepares the mind for a fruitful day. IQCoffee, with its perfect balance of caffeine, L-theanine, and essential nutrients, is not just a beverage, but a strategic ally for concentration and performance. As the body activates, the mind clarifies. The combination of cocoa and Coenzyme Q10 enhances brain bioenergetics, ensuring a constant flow of ideas and sound decisions. Green tea provides catechins that fight inflammation and stabilize energy, preventing daytime highs and lows. With each sip, the feeling of focus intensifies. There's no rush, just the certainty that the day ahead will be full of accomplishments and mental clarity.

After lunch, when the body relaxes and the mind threatens to slow down, comes the perfect time for a cup of coffee that revitalizes without overwhelming you. IQCoffee, with its balanced blend of caffeine, L-tea, and adaptogens, it awakens the senses without generating the nervousness of overstimulation. Coenzyme Q10 reactivates cellular energy production, helping to combat post-prandial heaviness. Cocoa, with its flavonoids, improves cerebral circulation, dispelling any hint of mental fatigue. Meanwhile, Rhodiola Rosea modulates the stress response, ensuring a serene and sustained focus to face the second half of the day with the same lucidity as in the morning. With each sip, clarity returns, ideas flow, and the work rhythm is precisely reset. It's more than a coffee; it's the necessary reset to close the day successfully.

There are times when unexpected news shakes the balance of the day, leaving a mixture of tension and mental exhaustion. In those moments, a coffee is not just a beverage, but an anchor, a ritual that helps restore clarity and composure. IQCoffee, with its combination of caffeine and L-theanine, provides a state of alertness without anxiety, allowing you to process information with serenity. Rhodiola rosea, known for its ability to modulate the stress response, stabilizes the nervous system and prevents emotional burnout. Cocoa, with its ability to increase serotonin production, provides a subtle sense of well-being that helps you view the situation from a more balanced perspective. Each sip is a deep breath, a moment to recalibrate the mind and take control of your emotions. With calm restored, the next step becomes clearer, and the day, although challenging, moves forward with determination.

That coffee with friends that accompanies laughter and deep conversations, that envelops the atmosphere in a warm aroma while stories flow naturally. It's the perfect excuse to prolong the evening, to make time stand still between anecdotes and future plans. A coffee shared with friends isn't just a drink; it's a moment of connection, a ritual that unites and comforts, filling the evening with energy and connection. That coffee becomes the bridge between like-minded souls, where each sip awakens memories and sparks new ideas. In the warmth of the cup, time becomes relative, words flow unhurriedly, and laughter resonates like the best echo of friendship. It's more than a drink; it's the invisible bond that unites those who share authentic moments, transforming a simple evening into an unforgettable moment. It would be a coffee designed to accompany nights of conversation and laughter, a blend that would enhance enjoyment and connection among friends. It would have a specialty coffee base with chocolatey or fruity notes, medium-roasted to achieve a perfect balance between body and smoothness. It would be enriched with dry ground cocoa, providing an indulgent touch that would stimulate the production of endorphins and promote a shared feeling of well-being. Ashwagandha would act subtly to reduce stress and maintain a state of relaxation without affecting mental clarity. A touch of cinnamon or cardamom would enhance the aromas, making each sip envelop the environment in a spicy warmth that would invite prolonged conversation. Dried ground coconut would add a velvety texture and provide sustained energy without creating heaviness. L-theanine would balance the caffeine, allowing for serene and focused mental stimulation, ideal for an evening in which time would seem to stand still amid stories, anecdotes, and future plans.

That coffee shared with our partner as a prelude to intimate moments would be a coffee that would awaken the senses and set the mood for the deepest connection. It would have a base of select beans with notes of vanilla and caramel, smooth and enveloping, capable of creating a warm and sensual atmosphere. It would be enriched with ground cocoa, enhancing the release of dopamine and endorphins, stimulating pleasure and complicity. A touch of maca would act as a natural tonic, increasing energy and desire without disturbing the harmony of the moment. Cinnamon would bring its spicy warmth, intensifying the aromas and enlivening the feeling of closeness. The combination of coffee and L-theanine would balance stimulation and relaxation, allowing for a fluid and spontaneous connection. A subtle base of cardamom or ginger would add an intriguing nuance, preparing the body and mind to surrender unhurriedly, allowing the evening to flow naturally and charmingly.

The coffee to share with a lover on the first encounter would be an intense and seductive coffee, with smoky notes and an enveloping body that would invite leisurely conversation and prolonged glances. It would be infused with a touch of bitter cocoa, awakening sensuality with its velvety depth. Vanilla would add a subtly sweet undertone, creating a feeling of comfort and effortless attraction. A pinch of cardamom or anise would elevate the experience with an exotic and enchanting air. Mysterious, leaving an intriguing aftertaste inviting further exploration. The combination of caffeine and L-theanine would offer a serene lucidity, perfect for reading between the lines and anticipating every gesture. Served in a low glass or a handcrafted ceramic cup, it would become the prelude to a budding complicity, where time would dissolve between slow sips and words laden with possibilities.

That coffee after sex, but eager to continue enjoying it. It would be a dense and enveloping coffee, with a silky texture that would melt into the still-warm skin and the awakened senses. The perfect blend would integrate an intense espresso with notes of cocoa and a touch of cinnamon, stimulating circulation and prolonging the latent energy in the body. A slight hint of ginger would add a touch of excitement, maintaining the feeling of desire in the atmosphere. Vanilla would provide a soft and lingering aftertaste, evoking the pleasure that still vibrates with every heartbeat. Served in a small cup, just enough to savor between pauses and caresses, it would be a bridge between rest and continuation, a tacit invitation to continue exploring without haste, with the certainty that the night still holds secrets to be discovered.

We now move on to describe several practical examples of how iQCoffee could work in different aspects of everyday life, although we have already made it clear that this proposed invention is interactive in the broadest sense of the word. It is a system designed to evolve over time according to the interactions that occur and open without limits to new products that emerge with the advancement of scientific advances.

IQCoffee could prove to be a catalyst for human transformation in multiple dimensions and achieve the goal of healthy longevity. Through its combination of active ingredients designed to optimize brain function, regulate metabolism, and improve body homeostasis, it could also become a key tool for creativity, concentration, physical and mental recovery, as well as for exploring advanced states of consciousness. Below, we present some representative examples of its potential impact in different scenarios to give you an idea of what could be achieved if the patent for the System and Method for the Production and Consumption of Intelligent Coffee (IQCoffee) is approved.

In the first case, we have a 42-year-old researcher dedicated to the study of theoretical physics who could face a series of health problems that would compromise his cognitive performance and overall well-being. If he were to suffer from diabetes and aggravated metabolic syndrome, with digestive problems and sexual dysfunction, this person could experience constant mental fatigue and marked difficulty maintaining concentration during intense work sessions. He could also seek to achieve deep states of relaxation and meditation to improve his mental clarity and creativity. Initially, the IQCoffee formulation could include caffeine combined with L-theanine in proportions designed to induce a balance between neuronal excitation and relaxation, stabilizing brain activity in alpha and theta waves. This initial version could allow the patient to experience a clearer state of mind, with improvements in stress management and a prolonged ability to focus. However, if after a month of consumption, it is identified that the patient's metabolism is not processing glucose efficiently, a specific reformulation may be required.

The composition of IQCoffee could be adjusted by adding berberine, an alkaloid with regulatory effects on insulin sensitivity, as well as Ceylon cinnamon, known for its ability to stabilize blood glucose levels. In parallel, ginger and digestive enzymes could be introduced to improve nutrient absorption and alleviate digestive issues. These modifications could allow the patient to stabilize their glycemic profile over a period of two months, reducing insulin spikes and significantly improving their daily energy. As his metabolism improved, a third phase of optimization could be added with ashwagandha and Peruvian maca, two adaptogens that would regulate his stress response and enhance endocrine function. These additions could have a positive impact on his hormonal balance, restoring his sexual health and strengthening his resistance to physical and mental exhaustion. With this final adjustment, he could be able to maintain sustained performance in his research without experiencing the fatigue that had plagued him for years.

Over the course of six months, the evolution of his personalized IQCoffee could allow him to reach a level of physiological stability that would completely transform his life. or his intellectual performance and overall well-being. With a more focused mind, improved metabolic response, and a capacity for deep relaxation, he could significantly advance his research and explore new theoretical approaches with a mental clarity that had previously been unattainable. This case would exemplify how an adaptive formulation of IQCoffee could become a fundamental tool for the comprehensive optimization of human performance.

IQCoffee could also prove to be a revolutionary tool in optimizing cognitive performance and restoring physiological balance. Let's now analyze the hypothetical case of a 54-year-old businessman, trapped in a grueling routine of endless meetings and strategic decisions. The effects of chronic stress and mental exhaustion could become evident. If his constant travel around the world disrupted his circadian rhythm, severe insomnia could worsen, resulting in persistent fatigue, high triglyceride and cholesterol levels, and recurring chest tightness that would make him fear for his life. Panic attacks and the loss of sexual potency could plunge you into a constant state of anxiety, affecting your leadership and decision-making abilities.

The initial IQCoffee formulation for your case might combine sustained-release caffeine with L-theanine and Rhodiola rosea, with the goal of improving your resistance to stress and stabilizing your cortisol levels. During the first few weeks, you might experience a temporary improvement in your energy and mental clarity, but if insomnia and chest tightness persist, your IQCoffee could be reformulated to incorporate magnesium, ashwagandha, and GABA, promoting more effective regulation of the autonomic nervous system and a progressive reduction of the sympathetic hyperactivity that fuels your panic episodes.

Over time, your metabolic system might begin to respond positively, reducing triglyceride and cholesterol levels thanks to the incorporation of cocoa polyphenols and bergamot extract into the formula. This could not only improve his lipid profile but also contribute to the reduction of systemic inflammation. As his body stabilized, Coenzyme Q10 and L-citrulline could be added, optimizing cardiovascular function and restoring his overall vitality. In a matter of months, his resistance to stress could increase significantly, his sleep could be regulated naturally, and his sexual potency could be restored, allowing him to resume his life with renewed energy.

The process of continuously adjusting the IQCoffee formulation based on his specific needs could be key to his transformation. What began as an attempt to stay alert during his work routine could eventually become a truly comprehensive recovery strategy, providing him not only mental clarity and sustained focus, but also a physiological stability that would redefine his quality of life.

IQCoffee could also work in extreme cases, such as a 65-year-old man who had suffered an ischemic stroke affecting key areas of his motor and language cortex, compromising his mobility and cognitive abilities. Her ability to speak and remember would be impaired, and doctors would consider a full recovery unlikely due to the extent of the neuronal damage.

To address this challenge, her recovery protocol could include a specific formulation of IQCoffee, designed to enhance neuroplasticity and long-term neuronal repair. The initial combination would contain caffeine and L-theanine, modulating brain activity to promote alertness without over-arousal, which could optimize concentration and facilitate motor rehabilitation. Additionally, bacopa monnieri and phosphatidylserine would be incorporated, two compounds with evidence of improving memory and strengthening neuronal synapses.

During the first few weeks, the activation of brain-derived neurotrophic factor (BDNF) would stimulate the formation of new synaptic connections, a crucial process in post-stroke recovery (Bekinschtein et al., 2011). However, to further enhance her regeneration, her IQCoffee formulation would evolve, including citicoline and alpha-lipoic acid, both recognized for their effects on neuronal membrane restoration and oxidative stress reduction (Secades & Lorenzo, 2006).

As her mobility and language skills began to improve, her IQCoffee protocol could incorporate ginseng and rhodiola rosea, two adaptogens that promote neuronal resistance to stress and improve the regulation of the dopaminergic system, which is key to motivation and mood (Panossian & Wikman, 2010). At the same time, supplementation with DHA and Coenzyme Q10 would optimize mitochondrial function, ensuring an efficient energy supply for neurogenesis and cellular repair.

Over the course of a year, with an appropriate nutritional and rehabilitation strategy, their cognitive capacity could improve significantly, with a recovery of up to 85% of their mobility and verbal fluency. This process would demonstrate how an adaptive formulation of IQCoffee could play a crucial role in neuroregeneration, facilitating the recovery of patients with severe neurological conditions. This is a borderline case, but also probable due to the plasticity of the data platform that IQCoffee would consist of.

We could refer to countless hypothetical cases, as life is almost infinite in terms of possible variables. Since no case is similar to another, no matter how analogous their circumstances, there is always something that distinguishes and personalizes it. I am convinced that personalized functional medicine is emerging as the medicine of the future, where the focus will be on preventing people from getting sick. This makes perfect sense, as fewer people would need to be treated, making the process more humane and more cost-effective. Below, we continue to present some examples of approaches in which IQCoffee could play a very important role, focusing on various general aspects of human behavior, such as:

Emotional balance and longevity, something very in vogue these days and something that a significant portion of people on the planet are concerned about. Longevity would not depend solely on biology, but also on emotional health. To maintain a balance between body and mind, a daily protocol could be established that includes IQCoffee with green tea and ashwagandha. The combination of caffeine with L-theanine promotes concentration and prevents mental exhaustion, while ashwagandha regulates the HPA axis, reducing the negative effects of stress on the body. The epicatechin from the cocoa in the blend stimulates the production of BDNF, promoting neuroplasticity and helping maintain a youthful and resilient mind. Following this routine would lead to greater emotional stability, which would directly impact overall well-being. Fatigue would significantly decrease, and the ability to face life's challenges would improve, reflecting the positive effects of a holistic approach to the pursuit of full and conscious longevity.

The relationship between gut microbiota and overall health could be crucial for long-term well-being. For those facing digestive issues such as irritable bowel syndrome, a natural and effective solution could be found in the combination of IQCoffee with dried ground coconut and zinc. Coconut provides medium-chain triglycerides, which are easily metabolized without generating inflammation, and contains prebiotic fiber capable of nourishing the beneficial bacteria in the gut. Zinc contributes to the repair of the intestinal mucosa and strengthens the epithelial barrier, reducing permeability and preventing autoimmune responses.

Incorporating this beverage into a daily routine would result in improved digestion, a reduction in bloating, and more regular intestinal transit. This strategy, based on a balance between nutrition and intestinal function, would promote greater digestive stability and sustained well-being over time. Digestive well-being would largely depend on the balance between the gut and the nervous system. To address disorders such as intestinal dysbiosis, Crohn's disease, and ulcerative colitis, an effective strategy could include consuming IQCoffee with green tea, Rhodiola Rosea, and ashwagandha. This combination would provide stable energy while reducing intestinal inflammation and modulating the gut-brain axis. The L-theanine present in green tea contributes to relaxation without causing sedation, decreasing the nervous system's response to stress, a key factor in digestive problems. Rhodiola rosea helps regulate cortisol levels, reducing the impact of stress on intestinal motility and preventing episodes of irritable bowel syndrome. Regular consumption of this blend may promote better food assimilation, reduce abdominal inflammation, and improve a greater sense of overall well-being.

Endurance athletes often face digestive problems due to the frequent consumption of protein supplements and high-carbohydrate diets. To counteract these effects, incorporating IQCoffee with cocoa and zinc could be an effective solution. Cocoa promotes the production of fatty acids. Short-chain triglycerides in the gut, which would improve microbiota health and reduce inflammation. Zinc, meanwhile, would play a crucial role in the regeneration of the intestinal epithelium and the production of digestive enzymes, facilitating nutrient absorption. Regular consumption could reduce digestive discomfort during training, optimize the absorption of essential nutrients, and sustainably improve physical performance. Constant training requires strategies that maximize energy and accelerate recovery without compromising mental state. A combination of IQCoffee with dried ground coconut and zinc before morning sessions could provide a quick and sustained source of energy thanks to the coconut's medium-chain triglycerides. Caffeine, together with Coenzyme Q10, would boost mitochondrial capacity, improving both physical and mental endurance during prolonged training sessions. Green tea may help reduce inflammation after intense sessions, while Rhodiola Rosea may optimize oxygen utilization, promoting more efficient aerobic performance. By integrating this strategy into a biohacking protocol, one may experience less muscle fatigue and faster recovery, allowing for more intense training without compromising overall well-being.

The development of regenerative therapies requires sustained concentration and optimal mental state. In this context, the addition of IQCoffee with cocoa and Coenzyme Q10 could represent an effective strategy to boost cognitive performance and resistance to mental burnout. Cocoa may stimulate nitric oxide production, promoting blood circulation and ensuring adequate cerebral oxygenation. Coenzyme Q10, in addition to improving mitochondrial efficiency, may protect against oxidative damage and chronic inflammation, factors closely linked to aging. The synergy between caffeine and L-theanine may allow one to maintain a state of deep concentration without causing mental fatigue. By regularly integrating this combination into one's daily routine, improvements in cognitive function and the ability to maintain a high level of productivity without compromising overall well-being could be observed.

The search for effective strategies to extend longevity and improve quality of life has led to the development of protocols based on scientifically supported habits. Within this approach, consuming IQCoffee with dried ground coconut, zinc, and Rhodiola Rosea could offer significant benefits for optimizing metabolism and preserving cognitive function. The medium-chain triglycerides present in coconut provide a stable and efficient source of energy, reducing dependence on glucose and promoting autophagy, an essential mechanism for cellular regeneration and maintenance. Zinc, by promoting DNA repair and strengthening the immune system, may contribute to protection against premature aging. Rhodiola Rosea, meanwhile, may improve resistance to stress and preserve mental agility, reducing the impact of cognitive decline. With consistent application of this protocol, it would be possible to observe improvements in overall vitality, reflected in healthier skin, stronger joints, and an agile mind, challenging the conventional limits of biological age.

Healthy aging would require a preventative approach that prioritizes cellular optimization over disease treatment. Within this framework, consuming IQCoffee with green tea and Coenzyme Q10 could represent an effective strategy to improve mitochondrial function and mitigate the impact of oxidative stress, two determining factors in longevity. Coenzyme Q10 would promote ATP production, providing sustained energy levels and protecting cells against premature senescence. Green tea catechins would act as potent antioxidants, reducing inflammation and strengthening the cardiovascular system. The combination with ashwagandha and Rhodiola rosea would contribute to cortisol balance, minimizing the negative effects of chronic stress on the body. By implementing this strategy, improvements in vitality and mental clarity could be observed, allowing for optimal physical and intellectual performance to be maintained over the years.

Exploring the human mind and producing complex ideas would require a highly creative state of mind and prolonged concentration. To achieve this, a combination of IQCoffee with Coenzyme Q10 and cocoa could enhance brain bioenergetics, ensuring a constant and structured flow of ideas. The synergy between caffeine and L-theanine would promote states of deep concentration, minimizing distractions and avoiding adverse effects. s such as anxiety. Ashwagandha contributes to emotional regulation, reducing stress and facilitating fluidity in the expression of ideas. By integrating this strategy into your creative routine, you may experience fewer mental blocks and a greater ability to organize complex concepts, optimizing both the quality and depth of thought.

Working in environments that demand high analytical skills and prolonged concentration requires strategies that optimize mental performance without generating fatigue. A combination of IQCoffee with green tea and cocoa can provide key benefits in this regard. The epicatechin present in cocoa stimulates neurogenesis and synaptic plasticity, promoting more efficient information processing. L-theanine modulates the effects of caffeine, avoiding peaks of arousal and promoting a state of relaxed attention that facilitates sustained work. Ashwagandha, a potent adaptogen, contributes to the regulation of cortisol levels, helping to manage stress without affecting cognitive performance. By integrating this blend into your daily routine, it's possible to reduce mental fatigue and improve your ability to solve complex problems without the need for extended breaks. Optimal performance in complex surgeries requires a precise balance of sustained energy, mental clarity, and stress management. A combination of IQCoffee with Coenzyme Q10 and Rhodiola Rosea can be key to maintaining a high level of concentration without causing fatigue. Coenzyme Q10 optimizes ATP production in cells, ensuring a constant flow of energy to the prefrontal cortex, a key region for decision-making and fine motor coordination. Rhodiola Rosea, meanwhile, modulates the stress response, promoting a state of calm focus during prolonged procedures. The combination of caffeine and L-theanine provides a sustained state of alertness without generating tremors or anxiety, allowing you to maintain the precision necessary for each task. Incorporating this blend into your daily routine can promote mental clarity and reduce exhaustion at the end of the day, optimizing performance during demanding workdays. The creative process requires a delicate balance between deep concentration and fluid intuition. For those seeking to achieve states of sustained inspiration, IQCoffee with cacao, L-theanine, and ashwagandha can be a key tool. Cacao, rich in epicatechins, stimulates neurogenesis and synaptic plasticity, enhancing the connection between ideas and facilitating the structuring of complex concepts. L-theanine modulates the effects of caffeine, promoting a state of relaxed attention, ideal for creativity without mental blocks. Ashwagandha, an essential adaptogen, balances cortisol levels and reduces stress, allowing for a creative flow without emotional distractions. This synergy promotes a meditative and intuitive state of mind, characteristic of artists and thinkers who seek to transcend the conventional limits of the mind.

Every morning begins with a ritual: the first sip of coffee, that moment when the intense aroma awakens the senses and prepares the mind for a fruitful day. IQCoffee, with its perfect balance of caffeine, L-theanine, and essential nutrients, is not just a beverage, but a strategic ally for focus and performance. As the body activates, the mind clarifies. The combination of cocoa and Coenzyme Q10 boosts brain bioenergetics, ensuring a steady flow of ideas and sound decisions. Green tea provides catechins that fight inflammation and stabilize energy, preventing ups and downs throughout the day. With each sip, the feeling of focus intensifies. There's no rush, only the certainty that the day ahead will be full of achievements and mental clarity.

After lunch, when the body relaxes and the mind threatens to slow down, the perfect time for a coffee that revitalizes without overwhelming you. IQCoffee, with its balanced blend of caffeine, L-theanine, and adaptogens, awakens the senses without generating the jitters of overstimulation. Coenzyme Q10 reactivates cellular energy production, helping to combat postprandial heaviness. Cocoa, with its flavonoids, improves cerebral circulation, dispelling any hint of mental fatigue. Meanwhile, Rhodiola Rosea modulates the stress response, ensuring a serene and sustained focus to face the second half of the day with the same lucidity of the morning. With each sip, clarity returns, ideas flow, and the work rhythm is seamlessly reset. It's more than just a cup of coffee; it's the reset needed to close the day successfully.

There are times when unexpected news shakes the balance of the day, leaving a mixture of tension and mental exhaustion. In those moments, a cup of coffee is not just a drink. Not just an anchor, but an anchor, a ritual that helps regain clarity and composure. IQCoffee, with its combination of caffeine and L-theanine, provides a state of alertness without anxiety, allowing you to process information with serenity. Rhodiola Rosea, known for its ability to modulate the stress response, stabilizes the nervous system and prevents emotional burnout. Cocoa, with its ability to increase serotonin production, provides a subtle sense of well-being that helps you view the situation from a more balanced perspective. Each sip is a deep breath, a moment to recalibrate the mind and take control of your emotions. With calm restored, the next step becomes clearer, and the day, although challenging, moves forward with determination.

That coffee with friends that accompanies laughter and deep conversations, that envelops the atmosphere in a warm aroma while stories flow naturally. It's the perfect excuse to prolong the evening, to make time stand still between anecdotes and future plans. A coffee shared with friends isn't just a drink; it's a moment of connection, a ritual that unites and comforts, filling the evening with energy and connection. That coffee becomes the bridge between like-minded souls, where each sip awakens memories and sparks new ideas. In the warmth of the cup, time becomes relative, words flow unhurriedly, and laughter resonates like the best echo of friendship. It's more than a drink; it's the invisible bond that unites those who share authentic moments, transforming a simple evening into an unforgettable moment. It would be a coffee designed to accompany nights of conversation and laughter, a blend that would enhance enjoyment and connection among friends. It would have a specialty coffee base with chocolatey or fruity notes, medium-roasted to achieve a perfect balance between body and smoothness. It would be enriched with dry ground cocoa, providing an indulgent touch that would stimulate the production of endorphins and promote a shared feeling of well-being. Ashwagandha would act subtly to reduce stress and maintain a state of relaxation without affecting mental clarity. A touch of cinnamon or cardamom would enhance the aromas, making each sip envelop the environment in a spicy warmth that would invite prolonged conversation. Dried ground coconut would add a velvety texture and provide sustained energy without creating heaviness. L-theanine would balance the caffeine, allowing for serene and focused mental stimulation, ideal for an evening in which time would seem to stand still amid stories, anecdotes, and future plans.

That coffee shared with our partner as a prelude to intimate moments would be a coffee that would awaken the senses and set the mood for the deepest connection. It would have a base of select beans with notes of vanilla and caramel, smooth and enveloping, capable of creating a warm and sensual atmosphere. It would be enriched with ground cocoa, enhancing the release of dopamine and endorphins, stimulating pleasure and complicity. A touch of maca would act as a natural tonic, increasing energy and desire without disturbing the harmony of the moment. Cinnamon would bring its spicy warmth, intensifying the aromas and enlivening the feeling of closeness. The combination of coffee and L-theanine would balance stimulation and relaxation, allowing for a fluid and spontaneous connection. A subtle base of cardamom or ginger would add an intriguing nuance, preparing the body and mind to surrender unhurriedly, allowing the evening to flow naturally and charmingly.

The coffee to share with a lover on the first encounter would be an intense and seductive coffee, with smoky notes and an enveloping body that would invite leisurely conversation and lingering glances. It would be infused with a touch of bitter cocoa, awakening sensuality with its velvety depth. Vanilla would add a subtly sweet undertone, creating a feeling of comfort and effortless attraction. A hint of cardamom or anise would elevate the experience with an exotic and mysterious air, leaving an intriguing aftertaste inviting further exploration. The combination of caffeine and L-theanine would offer a serene lucidity, perfect for reading between the lines and anticipating every gesture. Served in a low glass or a handmade ceramic cup, it would become the prelude to a budding complicity, where time would dissolve between slow sips and words laden with possibilities.

That coffee after sex, but with a strong desire to continue enjoying it. It would be a dense and enveloping coffee, with a silky texture that would melt into the still-warm skin and the awakened senses. The perfect blend would integrate an intense espresso with notes of cocoa and a touch of cinnamon, stimulating circulation and prolonging the latent energy in the body. A slight hint of ginger would add a touch of excitement, Maintaining the sensation of desire in the atmosphere. Vanilla would provide a soft and lingering aftertaste, evoking the pleasure that still vibrates with every heartbeat. Served in a small cup, just enough to savor between pauses and caresses, it would be a bridge between rest and continuation, a tacit invitation to continue exploring without haste, with the certainty that the night still holds secrets to be discovered.

1. A smart coffee brewing system comprising:
A biometric sensor module configured to collect real-time physiological data from the user, including, but not limited to, heart rate, stress levels, and sleep quality.
A data processing module that receives the physiological data and generates a user profile based on said data.
An artificial intelligence (AI) module that, using the user profile, determines a personalized coffee formulation by adjusting the concentration of bioactive ingredients according to identified needs.
A beverage preparation module that receives the customized formulation and adjusts the temperature, pressure, and coffee extraction time.
A blockchain-based traceability module that records the origin, processing, and certification of each bioactive ingredient in the coffee.
A nanotechnology and precision fermentation module that optimizes the bioavailability and absorption of bioactive compounds through microencapsulation and advanced bioprocesses.

2. A method for preparing a customized coffee beverage, comprising:
Collecting real-time physiological data from a user using biometric sensors.
Processing the physiological data to generate a user profile.
Determining a customized coffee formulation using artificial intelligence based on the user profile.
Preparing the coffee beverage by adjusting preparation parameters using a smart preparation module.
Recording and optimizing the formulation through blockchain traceability to ensure the authenticity and quality of the ingredients.
Applying precision fermentation techniques to enhance the bioactivity of the ingredients and improve their absorption in the body.

3. A functional coffee formulation comprising:
A coffee base enriched with selected adaptogens, including, but not limited to, Ashwagandha, Rhodiola rosea, and Siberian Ginseng.
Selected nootropics, including, but not limited to, L-theanine, Bacopa monnieri, and Huperzine A.
Highly bioavailable antioxidants, including, but not limited to Coenzyme Q10, cocoa polyphenols, and green tea flavonoids.
Selected essential minerals, including, but not limited to, zinc, copper, magnesium, and selenium, to enhance neurocognitive function.
Medium-chain triglycerides (MCTs) extracted from coconut to enhance energy absorption in the brain.
A precision microencapsulation and fermentation system to improve the stability and bioavailability of the active ingredients, or a variant with coconut milk enriched with bioactive supplements to enhance mitochondrial energy and longevity.

4. The system according to claim 1, wherein the biometric sensors are integrated into a wearable device selected from the group consisting of a smartwatch, an activity tracker, and a biometric ring.

5. The system according to claim 1, wherein artificial intelligence employs deep neural networks and predictive models to personalize the coffee formulation.

6. The system according to claim 1, wherein the smart coffee maker automatically adjusts the extraction temperature and pressure based on the user's biometric data.

7. The system according to claim 1, wherein blockchain-based traceability allows users to access real-time information about the origin, processing, and certification of each batch of coffee.

8. The formulation according to claim 3, wherein medium-chain triglycerides (MCTs) optimize the bioavailability of fat-soluble compounds such as Coenzyme Q10 and cocoa flavonoids.

9. The formulation according to claim 3, wherein adaptogens regulate cortisol and dopamine production, improving stress resistance and concentration.

10. The method according to claim 2, wherein the coffee formulation adjustment is based on physiological models that predict the user's metabolic state and nutritional requirements.

11. The system according to claim 1, wherein a smart coffee maker connected to the AI platform adapts each coffee preparation based on the user's needs.

12. The system according to claim 1, wherein the digital interface allows real-time monitoring of the physiological effects of coffee with personalized recommendations.

13. The formulation according to claim 3, wherein the combination of cocoa, green tea, and coffee generates a synergistic effect in improving memory and resistance to oxidative stress.

14. The method according to claim 2, wherein the coffee customization can be adjusted to optimize post-exercise recovery by including specific electrolytes and amino acids.

15. The system according to claim 1, wherein the artificial intelligence module can be synchronized with digital health platforms such as Apple Health and Google Fit to optimize the formulation.

16. The formulation according to claim 3, wherein neurochemical modulators such as L-theanine and phenylethylamine are integrated to improve the user's focus and emotional well-being.

17. The system according to claim 1, wherein biomarker analysis allows metabolic trends to be detected and the coffee formulation to be adjusted based on longitudinal data from the user.

18. The method according to claim 2, wherein the personalized formulation is progressively optimized through machine learning to improve adaptation to the user's physiological changes over time.
